(19) United States
(12) Patent Application Publication
(10) Pub. No.: US 2026/0270064 A1
(43) Pub. Date: Sep. 10, 2026

(54) TOKENIZATION ARCHITECTURE FOR TRUSTED AI GENERATED OUTPUT

(71) Applicant: MAI LABS LLC, North Bay Village, FL (US)

(72) Inventor: Christopher P. Maiorana, North Bay Village, FL (US)

(21) Appl. No.: 19/662,132

(22) Filed: Apr. 29, 2026

Related U.S. Application Data
(63) Continuation-in-part of application No. 19/639,076, filed on Apr. 3, 2026.
(60) Provisional application No. 63/906,669, filed on Oct. 28, 2025.
(60) Provisional application No. 63/907,345, filed on Oct. 29, 2025.
(60) Provisional application No. 63/910,206, filed on Nov. 3, 2025.
(60) Provisional application No. 63/911,540, filed on Nov. 5, 2025.
(60) Provisional application No. 63/912,463, filed on Nov. 6, 2025.
(60) Provisional application No. 63/914,590, filed on Nov. 10, 2025.
(60) Provisional application No. 63/920,698, filed on Nov. 19, 2025.
(60) Provisional application No. 63/929,125, filed on Dec. 2, 2025.
(60) Provisional application No. 63/939,903, filed on Dec. 12, 2025.
(60) Provisional application No. 63/972,622, filed on Jan. 30, 2026.
(60) Provisional application No. 63/974,179, filed on Feb. 2, 2026.
(60) Provisional application No. 63/983,780, filed on Feb. 16, 2026.
(60) Provisional application No. 64/005,696, filed on Mar. 14, 2026.
(60) Provisional application No. 64/020,279, filed on Mar. 28, 2026.
(60) Provisional application No. 64/026,578, filed on Apr. 2, 2026.
(60) Provisional application No. 64/041,178, filed on Apr. 16, 2026.
(60) Provisional application No. 64/043,412, filed on Apr. 18, 2026.
(60) Provisional application No. 64/049,578, filed on Apr. 25, 2026.

(51) Int. Cl. H04L 9/32; G06F 40/284; G06F 40/30

(52) U.S. Cl. CPC H04L 9/3213; G06F 40/284; G06F 40/30

(57) ABSTRACT

A computer-implemented method for prioritizing authoritative source content within a transformer inference pipeline, the method comprising identifying an authoritatively bound role in at least one predefined semantic roles in an input request and conversational input from the predefined semantic roles prior to execution of transformer model, generating a populated authoritatively bound role in response to the authoritatively bound role and the data source, storing the populated authoritatively bound role in a fixed value buffer, tokenizing the populated authoritatively bound role into an authoritative token sequence, tokenizing the conversational input into a conversational token sequence, receiving a probabilistically inferred output from the transformer model in response to at least the conversational token sequence, and assembling a governed output corresponding to the structured output in response to inserting the populated authoritatively bound role stored in the fixed value buffer into identified locations of the probabilistically inferred output.

This application relates to U.S. Provisional Application No. 63/906,669, filed on Oct. 28, 2025. This application also relates to U.S. Provisional Application No. 63/907,345, filed on Oct. 29, 2025. This application also relates to U.S. Provisional Application No. 63/910,206, filed on Nov. 3, 2025. This application also relates to U.S. Provisional Application No. 63/911,540, filed on Nov. 5, 2025. This application also relates to U.S. Provisional Application No. 63/912,463, filed on Nov. 6, 2025. This application also relates to U.S. Provisional Application No. 63/914,590, filed on Nov. 10, 2025. This application also relates to U.S. Provisional Application No. 63/920,698, filed on Nov. 19, 2025. This application also relates to U.S. Provisional Application No. 63/929,125, filed on Dec. 2, 2025. This application also relates to U.S. Provisional Application No. 63/939,903, filed on Dec. 12, 2025. This application also relates to U.S. Provisional Application No. 63/972,622, filed on Jan. 30, 2026. This application also relates to U.S. Provisional Application No. 63/974,179, filed on Feb. 2, 2026. This application also relates to U.S. Provisional Application No. 63/983,780, filed on Feb. 16, 2026. This application also relates to U.S. Provisional Application No. 64/005,696, filed on Mar. 14, 2026. This application also relates to U.S. Provisional Application No. 64/020,279, filed on Mar. 28, 2026. This application also relates to U.S. Provisional Application No. 64/026,578, filed on Apr. 2, 2026. This application also relates to U.S. patent application Ser. No. 19/639,076, filed on Apr. 3, 2026. This application also relates to U.S. Provisional Application No. 64/041,178, filed on Apr. 16, 2026. This application also relates to U.S. Provisional Application No. 64/043,412, filed on Apr. 18, 2026. This application also relates to U.S. Provisional Application No. 64/049,578, filed on Apr. 25, 2026. Each mentioned application is hereby incorporated by reference in its entirety.

### FIELD OF THE INVENTION

The invention relates to generative content from large language models generally and, more particularly, to a method and/or apparatus for implementing a tokenization architecture for trusted AI generated output.

### BACKGROUND

Use of generative artificial intelligence (AI) is becoming increasingly popular. AI technology is developing rapidly. Training, updating and deploying AI technology is expensive. In order to monetize AI technology, while still investing on improvements, many AI systems are available but only have limited guardrails. Even if AI models become extremely accurate, conventional AI technology are probabilistic systems. A well-known shortcoming of probabilistic systems is that they can occasionally produce an incorrect value (i.e., hallucinations, AI slop, etc.). While probabilistic reasoning can provide flexible language generation, probabilistic reasoning also means that generated outputs can include inferred or extrapolated information that is not directly grounded in authoritative data. Generative models are optimized for probabilistic inference, and not authoritative data retrieval. Many generative AI models err on the side of providing output, even if the requested information is unavailable. In contexts where the output values must be exact (i.e., such as a patient medical records, medical prescription dosages, legal citations, financial transactions, etc.) generative AI models may inject probabilistically inferred content where a deterministic resolution is required. End users often rely on prompt engineering to attempt to retrieve accurate information, or multiple requests to seek more accurate information. However, generative models still rely on probabilistic inference.

It would be desirable to implement a tokenization architecture for trusted AI generated output.

### SUMMARY

The present invention is one application in a pipeline of filings directed to a comprehensive architecture for governing the behavior of generative artificial intelligence systems. Unconstrained probabilistic inference produces a spectrum of output failures that extend well beyond outright hallucination. At the extreme, a generative model fabricates content with no basis in fact. A more pervasive and dangerous failure mode is near-hallucination, where the artificial intelligence model generates output that is plausible, internally consistent, and confidently stated and yet diverges from authoritative reality in ways that are difficult to detect and catastrophic in high-stakes contexts. For example, near-hallucinations may be a patient weight that is close but wrong, a legal citation that exists but is misquoted, a financial parameter that reflects training data rather than the current record, etc.

Another failure mode that may be recognizable to anyone who has deployed a generative system in a production environment is when the artificial intelligence model is not hallucinating and is not obviously wrong, however the output simply seems off. For example, the reasoning drifts, the response addresses a slightly different question than the one asked, the output is technically accurate but contextually misaligned, or the model applies general knowledge where specific authoritative information was required and available. Such failures may be the most difficult to catch precisely because the failures do not trigger obvious error conditions, can pass review and may propagate downstream. In regulated environments, the errors can create liability. In autonomous agent workflows, the errors may produce cascading errors that are expensive to unwind.

Generally, the failures occur not because the model is broken but because probabilistic inference is the wrong tool for deterministic retrieval. Conventional systems have no architectural mechanism to enforce the boundary between probabilistic inference and deterministic retrieval. The architecture addressed across this pipeline of filings governs the boundary between inference and deterministic retrieval at every level of the reasoning process (e.g., execution authority, authoritative data binding, reasoning state management, epistemic input control, and/or collaborative reasoning governance). The architecture may ensure that probabilistic inference operates only where inference is appropriate, and is structurally prohibited where deterministic retrieval is required.

The architecture introduced across the pipeline of filings comprises multiple layers, each addressing the boundary between probabilistic inference and deterministic retrieval at a different point in the generative process. The present application is directed to the inference-pipeline tokenization layer. In the tokenization layer, authoritative content is structurally bound into the transformer input sequence prior to inference, and verbatim authoritative content is enforced in the output through a deterministic assembly mechanism. The deterministic assembly mechanism operates at identified locations independently from the transformer behavior. The tokenization architecture and the assembly architecture described herein are configured to operate within the broader governance framework introduced in related applications.

The present application is directed to a computer-implemented method for prioritizing authoritative source content within a transformer inference pipeline, the method comprising receiving an input comprising a request from an end user associated with structured output comprising one or more predefined semantic roles and a data source, identifying at least one of the predefined semantic roles as an authoritatively bound role and conversational input from the predefined semantic roles prior to execution of transformer model, generating a populated authoritatively bound role in response to the authoritatively bound role and the data source, storing the populated authoritatively bound role in a fixed value buffer, tokenizing the populated authoritatively bound role into an authoritative token sequence, tokenizing the conversational input into a conversational token sequence, receiving a probabilistically inferred output from the transformer model in response to at least the conversational token sequence, and assembling a governed output corresponding to the structured output in response to inserting the populated authoritatively bound role stored in the fixed value buffer into identified locations of the probabilistically inferred output.

### BRIEF DESCRIPTION OF THE FIGURES

Embodiments of the invention will be apparent from the following detailed description and the appended claims and drawings.

FIG. 1 is a block diagram illustrating an example embodiment of the present invention.

FIG. 2 is a block diagram illustrating deterministic role enforcement.

FIG. 3 is a block diagram illustrating a memory buffer architecture for a governance layer.

FIG. 4 is a block diagram illustrating an authoritative token sequencer architecture.

FIG. 5 is a block diagram illustrating an alternate embodiment of an authoritative token sequencer architecture.

FIG. 6 is a flow diagram illustrating a method for governing output of a generative AI engine to populate a structured output with validated content that is bound to an authoritative source.

FIG. 7 is a flow diagram illustrating a method for generating trusted AI output using a tokenization architecture that combines an authoritative token sequence with a conversational token sequence.

FIG. 8 is a flow diagram illustrating a method for generating trusted AI output using a tokenization architecture that generates a conversational token sequence and an authoritative token sequence using a different vocabulary.

FIG. 9 is a flow diagram illustrating a method for assigning tokens to a positional index in a combined token sequence.

### DETAILED DESCRIPTION OF THE EMBODIMENTS

Embodiments of the present invention include providing a tokenization architecture for trusted AI generated output that may (i) provide architectural separation between model training and model governance, (ii) implement input and output conditioning for generative systems, (iii) enable runtime governance of generative reasoning, (iv) provide an architectural overlay as an alternative to model replacement, (v) reduce costs and compute requirements for retraining models, (vi) perform tokenization for authoritative sources and input requests, (vii) provide a safety and/or accuracy overlay independent of the alignment of a model, (viii) ensure deployment stability across multiple domains, (ix) provide constraints for generative models, (x) assemble probabilistically inferred output with fixed authoritative sources, (xi) store authoritatively bound content in a fixed buffer, and/or (xii) be implemented as one or more integrated circuits.

Embodiments of the present invention may be configured to ensure probabilistic completion is subordinated to deterministic injection for generative artificial intelligence (AI) model output. Generally, generative AI models (e.g., a large language model (LLM)) perform probabilistic reasoning in response to an input prompt to generate output. Probabilistic reasoning may generate content that may be incorrect, inaccurate and/or fabricated. Various tasks may demand varying levels of accuracy for the generated output of an AI model. Ensuring that probabilistic completion may be subordinated to deterministic injection may enable the generative AI model to perform probabilistic reasoning with content guardrails. For example, the generative model may be constrained from having an authority to supply probabilistic output for protected output values. The protected output values may be restricted to values that may be validated from authoritative sources before generation may proceed.

Embodiments of the present invention may be configured to resolve system constraints before content generation. After the system constraints have been resolved, then the AI model may generate content within the defined constraints. For example, when a semantic role requires authoritative resolution (e.g., defined as protected output), the system may retrieve and validate the value first and then the model may generate content (e.g., text) around and/or in addition to the validated values (e.g., rather than inventing all of the content probabilistically). The probabilistic reasoning and the deterministic authority may be separate domains.

The system constraints may not necessarily restrict all of the content generated by the AI model. Generally, the AI model may generate explanations, narrative context, and/or reasoning chains. However, for certain semantic roles (e.g., protected content such as medical parameters, legal text, financial values, verified statistics, etc.) the model does not have permission to invent the value. Instead, the architecture of the present invention may inject deterministically retrieved data into the reasoning process and prevent the probabilistic model from substituting an inferred value.

Embodiments of the present invention may be configured to provide a deterministic boundary system for a reasoning engine. For example, the reasoning engine may operate within the deterministic boundary system. The AI model provides language generation and contextual reasoning, while the surrounding architecture may govern which semantic regions may be restricted to being resolved through authoritative data. The deterministic boundary system may enable the probabilistic intelligence to operate freely, while providing the structural boundaries that may ensure factual correctness for designated roles.

Embodiments of the present invention may be configured to operate and/or interact with semantic tokens (e.g., semantic units). The semantic units may not necessarily be identical to the final textual output produced by the generative AI engine. The semantic tokens may represent intermediate analytical elements that may be extracted from and/or associated with portions of generated content during a reasoning evaluation process. The generative AI engine may be configured to generate candidate text, narrative statements, structured reasoning steps, etc. In some embodiments, the generated content may be parsed and/or segmented into the semantic units that correspond to discrete assertions and/or factual propositions. Each semantic unit may be evaluated independently with respect to authoritative source material and/or retrieved evidence. The semantic tokens may function as analytical representations of meaning rather than merely raw output tokens from the generative AI engine. For example, the semantic tokens may correspond to a factual assertion, a numerical value, a citation statement and/or other information-bearing components that may be contained within the generated text. Embodiments of the present invention may be configured to apply classification operations (e.g., determining whether the assertion is citation-accurate, inferred, extrapolated, and/or unsupported).

The semantic tokens may be analyzed independently from the final textual output. Embodiments of the present invention may be configured to attach epistemic metadata to specific informational elements without altering the AI model implemented by the AI engine. The final output may comprise the original text generated by the AI engine, but the system may maintain an associated metadata structure indicating the epistemic classification of the underlying semantic units. In some embodiments, semantic units determined to be inferred may be filtered, annotated, and/or removed before the final output generation. In some embodiments, the semantic classification may be preserved as metadata for downstream reasoning analysis and/or execution gating. The output of the generative engine may be treated as one source of candidate reasoning, while the semantic tokens may provide a structured representation that may be evaluated against authoritative sources and/or policy constraints.

Generative models may be generally optimized for probabilistic inference. End users may rely on generative models for authoritative data retrieval. Embodiments of the present invention may provide constraints and/or guardrails that may prevent probabilistic inferences from being used where the output desired may be deterministic and/or authoritative content.

Embodiments of the present invention may provide a governance architecture that may operate in conjunction with a generative reasoning engine to ensure that specific semantic roles within a generated output may be populated using verified data obtained from authoritative sources. The reasoning engine may generate candidate reasoning content and/or narrative explanations, while a governance framework may identify predefined semantic roles that may be determined to require deterministic population (e.g., data cited accurately from an authoritative source). For semantic roles that may require deterministic population, the governance framework system may retrieve parameter values from authoritative data sources and/or ensure that the generative reasoning engine retrieves parameters values from authoritative data sources, apply validation constraints appropriate to the role(s), and/or prevent probabilistic generation from supplying the value for the role(s). By separating probabilistic reasoning from deterministic parameter enforcement, the governance framework system may allow generative reasoning models to perform analytical and/or explanatory functions while ensuring that critical factual parameters may be populated using verified information. Embodiments of the present invention may enable reliable operation across a wide range of generative models while preserving the accuracy required in applications where specific values must correspond to authoritative data.

Embodiments of the present invention may relate to an artificial intelligence governance architecture that may operate at a level of reasoning conditions rather than output correction. Conventional large language model systems generate outputs first and attempt to evaluate, filter, and/or correct the outputs after generation. In contrast, the architecture of the present invention may govern what reasoning is permitted to occur, when reasoning is allowed to proceed, and/or which information may influence the reasoning before inference is performed.

Embodiments of the present invention may separate execution from commitment. A reasoning process (e.g., implemented by a large language model) may proceed without restriction, but the outputs of the reasoning process may not be permitted to propagate, trigger downstream actions, and/or produce irreversible effects unless defined authority conditions are satisfied. The defined authority conditions may enable continuous reasoning while preventing unverified outputs from affecting external systems.

Embodiments of the present invention may separate the reasoning processes from interaction processes. Reasoning may occur in parallel, in advance, and/or subsequent to user interaction. In one example, the reasoning may be reused without recomputation. As a result, response latency, computational redundancy, and/or context reconstruction overhead are materially reduced.

Embodiments of the present invention may maintain a validated cognitive state distinct from a conversational transcript. For example, rather than reconstructing prior reasoning from accumulated text of the conversational transcript, the system may capture and/or reuse a validated reasoning state in a form that may be inserted and/or rehydrated across sessions, agents, and/or environments without reintroducing unvalidated context.

In some embodiments, the system may maintain multiple concurrent interpretations of ambiguous inputs. Responses may be generated immediately based on a primary interpretation while alternative interpretations may be preserved and selectively activated without restarting the reasoning process. In multi-actor environments, the architecture may govern a transfer, aggregation, and/or isolation of cognitive representations across participants under defined consent, provenance, and/or scope constraints. For example, governing across participants may enable a coordinated reasoning without collapsing independent reasoning trajectories.

At the input level, embodiments of the present invention may enforce an epistemic boundary that may define which information may be admissible for a given reasoning operation. Information determined to be outside of the defined epistemic boundary may be structurally excluded from influencing the reasoning process, regardless of the availability to the system of the out of bounds information. Embodiments of the present invention may provide an architectural enforcement mechanism rather than a behavioral mechanism, which may enable verifiable and/or auditable reasoning outputs.

Enforcement mechanisms implemented by various embodiments of the present invention may form a governance substrate in which reasoning may be bounded, timed, applied to an appropriate state, and/or authority-conditioned prior to execution. For example, the enforcement mechanisms implemented may reduce a reliance on post-generation information correction and produce systems that may be more reliable, auditable, and computationally efficient across a wide range of deployment environments.

Embodiments of the present invention may be configured to perform minimum binding. Minimum binding may be an operational expression of a minimum-anchor framing at the architectural level. The architecture may be configured to bind only what must be bound (e.g., a smallest set of authoritative content positions in the input embedding sufficient to ground correct generation) and leave all other positions free for inference. The bound positions may be structurally constrained to authoritative content. For example, the free positions may preserve full generative capacity of the AI model. By binding only what must be bound, the architecture may avoid binding too little (e.g., an anchor that may be insufficient to govern output) and/or avoid binding too much (e.g., waste generative capacity of the model on positions that should have been generated). The architecture may be configured to determine the correct boundary (e.g., binding what may be necessary while freeing what may not be necessary) to ensure that the AI model may operate at full capacity from a correct anchor rather than at degraded capacity from either over-constraint or under-constraint.

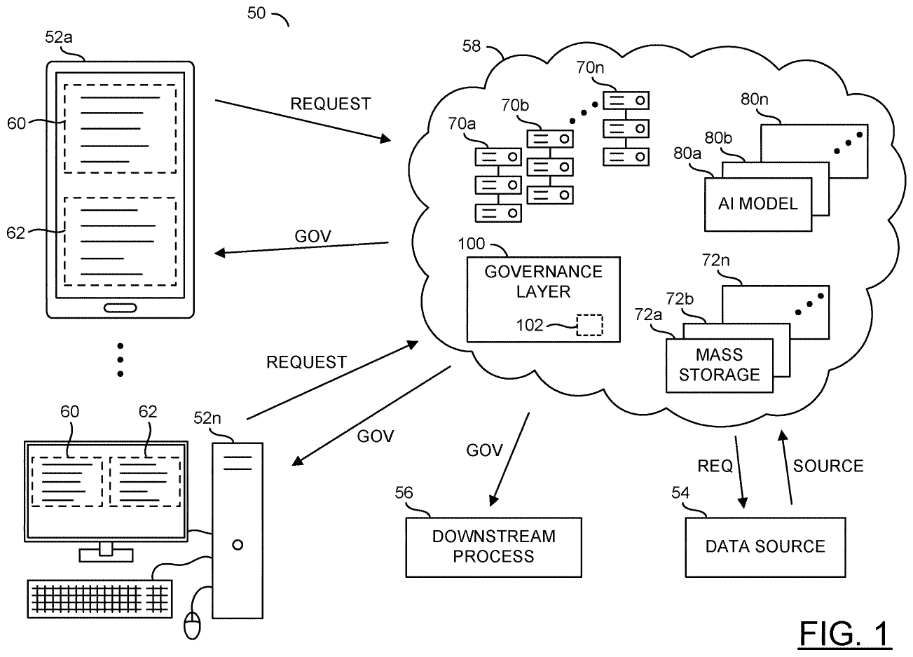

Referring to FIG. 1, a block diagram illustrating an example embodiment of the present invention is shown. A system 50 is shown. The system 50 may be an example cloud communication network. The cloud communication network 50 may enable interconnected devices to communicate with remote resources.

The cloud communication network 50 may comprise a cloud computing service 58 in communication with a number of client devices 52a-52n. The cloud communication network 50 may comprise a number of blocks (or circuits) 70a-70n, a number of blocks (or circuits) 72a-72n, a number of blocks (or circuits) 80a-80n and/or a block (or circuit) 100. The circuits 70a-70n may implement server computers. The circuits 72a-72n may comprise mass storage devices. The circuits 80a-80n may comprise AI models and/or AI engines. The circuit 100 may implement an apparatus and/or a system (e.g., a governance layer, content pre-filtering system, an output governance layer, etc.). The cloud communication network 50 may comprise other components (not shown). The number, type and/or arrangement of the components of the cloud communication network 50 may be varied according to the design criteria of a particular implementation.

The cloud computing service 58 may be configured to store data, retrieve and transmit stored data, process data and/or communicate with other devices. The server computers 70a-70n and/or the mass storage devices 72a-72n may be implemented as part of a cloud computing platform (e.g., distributed computing). In an example, the server computers 70a-70n and/or the mass storage devices 72a-72n may be implemented as a group of cloud-based, scalable server computers. By implementing a number of scalable servers, additional resources (e.g., power, processing capability, memory, etc.) may be available to process and/or store variable amounts of data. For example, the cloud computing service 58 may be configured to scale (e.g., provision resources) of the server computers 70a-70n and/or the mass storage devices 72a-72n based on demand. The cloud computing service 58 may implement scalable computing (e.g., cloud computing). The scalable computing may be available as a service to allow access to processing and/or storage resources without having to build infrastructure (e.g., the provider of the apparatus 100, the client devices 52a-52n and/or the AI engines 80a-80n may not have to build the infrastructure of the cloud computing service 58).

Each of the server computers 70a-70n may comprise memory and/or processors. Each of the mass storage devices 72a-72n may comprise storage devices (e.g., hard drives, solid state drives, etc.). The cloud computing service 58 may aggregate the resources provided by the server computers 70a-70n and/or the mass storage devices 72a-72n to provision resources based on demand. For example, cloud computing (e.g., processing) may be made available by provisioning the processing capabilities of the server computers 70a-70n. In another example, the storage capacity of the mass storage devices 72a-72n may enable the cloud computing service 58 to provide cloud storage services. The particular services available and/or the provision of the services of the cloud computing service 58 may be varied according to the design criteria of a particular implementation.

The cloud processing provided by the cloud computing service 58 may provide resources for implementing the AI engines 80a-80n. The AI engines 80a-80n may implement one or more machine learning models trained to generate natural language and/or structured reasoning outputs. For example, the machine learning models may comprise large language models (LLMs), transformer-based neural networks, vision-language models (VLMs), and/or other generative inference systems that may be capable of producing contextual responses based on input prompts and/or retrieved information. Generally, the AI engines 80a-80n may be configured to generate probabilistically inferred content. The particular types of models implemented by the AI engines 80a-80n may be varied according to the design criteria of a particular implementation.

The apparatus 100 may be implemented by the cloud computing service 58. In the example shown, the apparatus 100 may be shown as a separate component from the server computers 70a-70n, the mass storage devices 72a-72n and/or the AI engines 80a-80n for illustrative purposes. In some embodiments, the apparatus 100 may be integrated as part of one or more of the components of the cloud computing service 58. In one example, the apparatus 100 may comprise computer readable instructions that may be executable by the server computers 70a-70n in conjunction with the AI models 80a-80n. The operations and/or features provided by the apparatus 100 may be performed by the various resources provisioned by the cloud computing services 58. For example, the apparatus 100 may be implemented using various instruction sets (e.g., x86, x86-64, ARM, RISC-V, etc.) implemented by the processing devices (e.g., CPU, GPU, APU, NPU, etc.) of the server computers 70a-70n. The particular interactions of the apparatus 100 with the other components of the cloud computing service 58 may be varied according to the design criteria of a particular implementation.

The client devices 52a-52n may each be a computing device used by an end user. The client devices 52a-52n may be configured to receive input from the end user, communicate with external networks, store data, execute computer readable instructions, etc. For example, one or more of the client devices 52a-52n may comprise a smartphone, a tablet computing device, a desktop computer, a smartwatch, a smartphone, a laptop computer, a netbook computer, smart glasses, a vehicle infotainment system, etc. Generally, the client devices 52a-52n may comprise an output display, input peripherals (e.g., a keyboard, a touchscreen, a microphone, a mouse, a gamepad, etc.), a processor, a memory, etc. For example, the combination of the processor and the memory implemented by the client devices 52a-52n may enable the client devices 52a-52n to execute computer readable instructions (e.g., implement an operating system, execute programs/apps, receive/process input and generate output, etc.). The client devices 52a-52n may be configured to execute an operating system (e.g., Windows, MacOS, IOS, Linux, Android, Fushia, etc.). The client devices 52a-52n may be configured to implement processing devices such as a CPU, an APU, an NPU (e.g., an AI-accelerated processor) that may implement various instruction sets (e.g., x86, x86-64, ARM, RISC-V, etc.). In the example shown, the client device 52a may be a smartphone and the client device 52n may be a desktop computer. The type and/or implementation of the client devices 52a-52n may be varied according to the design criteria of a particular implementation.

The end user may generally be a person operating one or more of the client devices 52a-52n. In some embodiments, the end user may be a system (e.g., an automated system). In one example, an automated system may be programmed to make requests to the apparatus 100. In another example, the end user may be an AI controlled device. Whether the client devices 52a-52n are controlled directly by a person and/or an automated system may be varied according to the design criteria of a particular implementation.

The client devices 52a-52n are shown displaying content 60-62. In the example shown, the content 60-62 may be visually represented as content displayed on a screen. The content 60 may be an input. The content 62 may be an output. For example, the end user may provide the input content 60 to one of the client devices 52a-52n and the client devices 52a-52n may provide the output content 62 to the end user. The type of the content 60-62 may be varied according to the design criteria of a particular implementation.

The client devices 52a-52n are each shown generating a signal (e.g., REQUEST). The signal REQUEST may be communicated by the client devices 52a-52n to the cloud computing service 58. The signal REQUEST may comprise the input content 60 from the client devices 52a-52n. For example, the end user may provide the input content 60 to one or more of the client devices 52a-52n and the client devices 52a-52n may communicate the input content 60 to the cloud computing service 58. In the example of the cloud communication network 50 with the apparatus 100 and the AI engines 80a-80n, the signal REQUEST may comprise a query provided to the AI engines 80a-80n. For example, the end user may ask a natural language question as the input content 60 and the natural language question may be forwarded to the AI engines 80a-80n of the cloud computing service 58 to provide the answer.

The client devices 52a-52n are each shown receiving a signal (e.g., GOV). The signal GOV may be communicated by the cloud computing service 58 to the client devices 52a-52n. The signal GOV may comprise the output content 62 for the client devices 52a-52n. For example, the cloud computer service 58 may provide the output content 62 to one or more of the client devices 52a-52n and the client devices 52a-52n may display the output content 62 to the end user. In the example of the cloud communication network 50 with the apparatus 100 and the AI engines 80a-80n, the signal GOV may comprise a response to the query (e.g., a response to the signal REQUEST) generated by the AI engines 80a-80n. For example, the AI engines 80a-80n may provide the answer to the natural language question, which may be displayed by the client devices 52a-52n as the output content 62.

The cloud communication network 50 may further comprise a block (or circuit) 54 and/or a block (or circuit) 56. The circuit 54 may be a data source (e.g., an authoritative data source). The circuit 56 may be a downstream process. The data source 54 and/or the downstream process 56 may be configured to interact with the cloud computing service 58. For example, when providing the answer to the query received from the client devices 52a-52n, the apparatus 100 and/or the AI engines 80a-80n may further communicate with the data source 54 and/or the downstream process 56.

The data source 54 may be an authoritative data source. The authoritative data source 54 may be configured to receive a signal (e.g., REQ) and provide a signal (e.g., SOURCE). The signal SOURCE may be an input that may be used by the AI engines 80a-80n to provide the output GOV of the client devices 52a-52n and/or the downstream process 56.

The authoritative data source 54 may be configured to provide authoritative data. The signal SOURCE may comprise the authoritative data. The authoritative data may be distinct from probabilistically inferred data generated by the AI engines 80a-80n. The apparatus 100 may be configured to ensure that the authoritative data from the authoritative data source 54 is provided in response to the input provided by the client devices 52a-52n. For example, the authoritative data source 54 may provide ground truth data and/or data that may have deterministic authority.

The downstream process 56 may be a process and/or device that may use and/or rely on the output content 62. For example, the client devices 52a-52n may provide the input content 60 (e.g., the signal REQUEST), which may be used to provide the output content 62 (e.g., the signal GOV) that may be usable by the downstream process 56. The downstream process 56 may be configured to receive the signal GOV. Generally, the downstream process 56 may be agnostic to how the output content 62 of the signal GOV has been generated. For example, the downstream process 56 may be configured to use the data provided in the signal GOV without prior knowledge of how the data was acquired, whether the data is accurate, whether the data is reliable, etc. In one example, the downstream process 56 may be configured to communicate the output GOV back to the client devices 52a-52n. In another example, the downstream process 56 may save the output content 62 as a file on a computing device. In yet another example, the downstream process 56 may be an agentic response to the output content 62. In still another example, the downstream process 56 may comprise sending a prescription, approving a financial transaction, executing a treatment plan, filing a legal document, etc. The number and/or types of the downstream process 56 may be varied according to the design criteria of a particular implementation.

The apparatus 100 may be configured to control, filter, govern, etc. the data provided in the signal GOV. For example, without the apparatus 100, the output content 62 in the signal GOV may comprise inaccurate data, hallucinated data, near-hallucinated data, data resulting from AI model drift, unreliable data, etc. The apparatus 100 may be configured to bind the output of the AI engines 80a-80n to authoritative data retrieved from the authoritative data source 54. Generally, the apparatus 100 may operate transparently to the client devices 52a-52n and/or the downstream process 56. For example, any instructions and/or apps executed by the client devices 52a-52n and/or the downstream process 56 may not necessarily benefit from modification for compatibility with the apparatus 100 (e.g., the compatibility of the apparatus 100 may be inherent based on the architecture of the apparatus 100 and/or how the apparatus 100 interacts with the input/output of the AI engines 80a-80n).

The apparatus 100 may be implemented as part of a content generation system along with the AI engines 80a-80n. The apparatus 100 may be configured to pre-format input to the AI engines 80a-80n and/or filter output generated by the AI engine 80a-80n. For example, the apparatus 100 may modify and/or guide data to/from the AI engines 80a-80n without directly affecting the model implemented by the AI engines 80a-80n and/or operation of the AI engines 80a-80n.

The apparatus 100 may operate on semantic units derived from generated content and/or may directly analyze the internal token representations produced by the AI engines 80a-80n. Tokens generated by a language model may generally correspond to fragments of text used during probabilistic sequence generation and may not necessarily correspond to complete informational assertions. By contrast, the semantic units may represent higher-level informational elements extracted from the authoritative data source 54 that may correspond to discrete factual statements, parameter values, inferential assertions, etc. By operating at the semantic-unit level, the apparatus 100 may evaluate the meaning and/or authority of individual assertions, which may enable validation, filtering, and/or modification of specific informational elements without requiring access to the internal token-generation mechanisms of the underlying model of the AI engines 80a-80n. The semantic units may enable the apparatus 100 to function with a wide variety of generative models while maintaining consistent control over the informational content of the final output.

In some embodiments, the apparatus 100 may convert the ungoverned output generated by the AI engine 80a-80n into semantic units and/or operate at a token level. The apparatus 100 may enable downstream analysis modules (e.g., the downstream process 56) to evaluate and/or operate on individual informational assertions rather than treating the ungoverned generated output as a monolithic block of text. For example, the apparatus 100 may modify, annotate, filter, and/or replace specific semantic units when validation rules, inference distance thresholds, and/or epistemic classification policies indicate that the ungoverned generated content should be altered prior to final output generation.

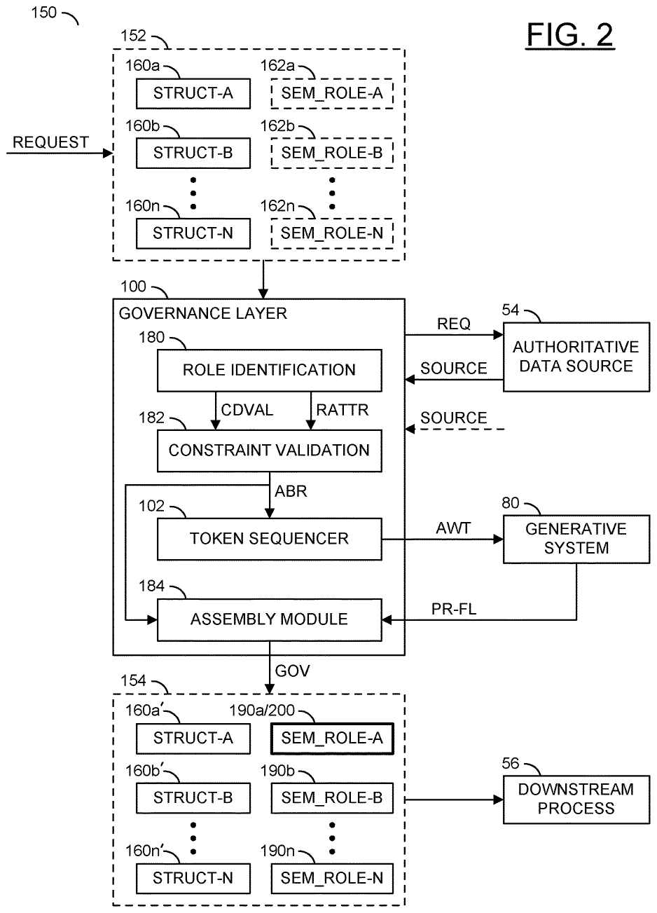

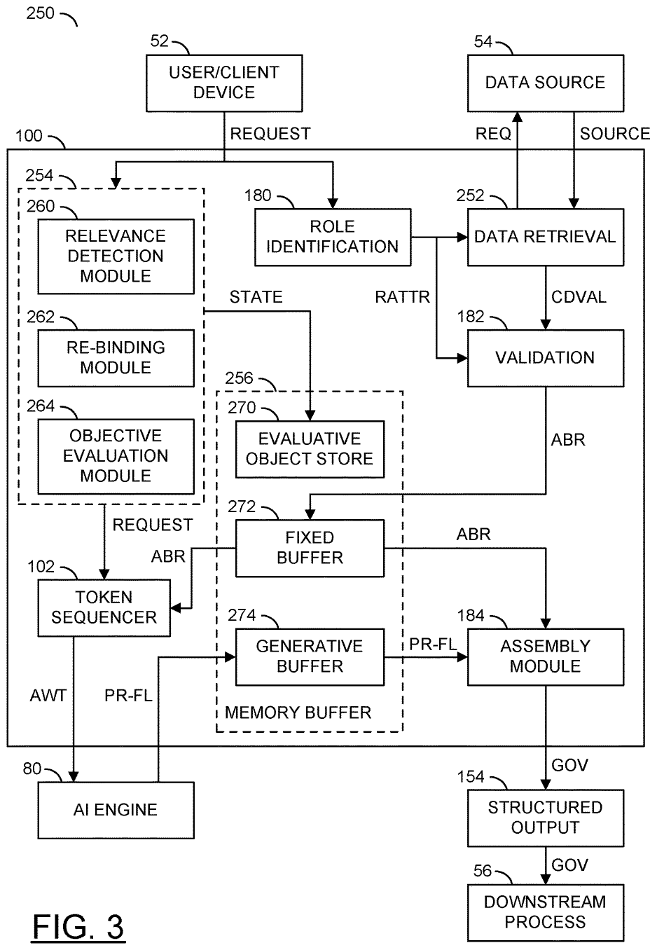

The apparatus 100 may comprise a block (or circuit) 102. The circuit 102 may implement a token sequencer. The apparatus 100 may comprise other components (to be described in association with FIG. 2 and/or FIG. 3). Details of the token sequencer 102 may be described in association with FIGS. 2-4. The number, type and/or arrangement of the components of the apparatus 100 may be varied according to the design criteria of a particular implementation.

Referring to FIG. 2, a block diagram illustrating deterministic role enforcement is shown. A system 150 is shown. The system 150 may implement a role enforcement system. The role enforcement system 150 may be configured to control a population of required semantic roles in a generative machine learning output.

The role enforcement system 150 may comprise the AI engine 80, the authoritative data source 54, the downstream process 56, the governance layer 100, a structured output template 152 and/or a structured output 154. The role enforcement system 150 may comprise other components (not shown). The number, type and/or arrangement of the components of the role enforcement system 150 may be varied according to the design criteria of a particular implementation.

The AI engine 80 may be a representative example of one of the AI engines 80a-80n described in association with FIG. 1. The AI engine 80 may be configured to produce candidate reasoning content in response to the signal REQUEST and/or a signal SOURCE. The AI engine 80 may receive an input comprising task instructions, contextual information, authoritative parameters retrieved from external data sources, etc. The AI engine 80 may use probabilistic inference to generate candidate content. The candidate content may comprise explanatory text, analytical reasoning, proposed structured outputs associated, etc. associated with a task. The generated content may be provided to downstream analysis modules (e.g., the two-pass governance layer 102 and/or other downstream processes) that may evaluate the ungoverned output.

The AI engine 80 may function as a generative inference component rather than an authoritative data source. The AI engine 80 may generate narrative explanations and/or propose candidate reasoning steps. The AI engine 80 may provide generative capability while the governance layer 100 may ensure that the resulting output may be consistent with authoritative data sources and/or system policies.

The signal REQUEST and the signal SOURCE may each be an input for the governance layer 100. In some embodiments, the signal REQUEST may comprise text input. For example, the text input may comprise a plain language description and/or natural language input (e.g., text that provides similar language to a person may use to communicate to another person). Generally, the text input may not necessarily require a particular format (e.g., may not require boolean formatting, may not require computing code, may not conform to a particular API, etc.). In some embodiments, the signal REQUEST may be text input provided by a person. The signal REQUEST may comprise text that may ask a question and/or instruct the governance layer 100 to generate output in a particular format. For example, the signal REQUEST may comprise a question, a command, instructions, a formatting directive (e.g., a structured output template), a task specification, a prompt, etc. The signal SOURCE may comprise authoritative data. The signal SOURCE may comprise other types of input. For example, the data provided in the signal SOURCE may comprise computer readable data formats such as a document (e.g., a .txt file, a .doc file, a .pdf file, a .docx file, a .xlx, file, a .odf file, etc.), an audio file (e.g., a .wav file, a .mp3 file, a .flac file, etc.), an image file (e.g., a .jpg, a .png, a .bmp, etc.), a video file (e.g., a .mp4 file, a .mkv file, a .mov file, etc.), etc. The signal SOURCE may comprise parameter values corresponding to at least one predefined semantic role. In some embodiments, the signal REQUEST may comprise text accompanying the computer readable data in the signal SOURCE (e.g., a question and/or instructions about a text file such as asking for a summary, asking for corrections, asking to fill in data, etc.). For example, the data source in the signal SOURCE may be used to analyze and/or respond to the input in the signal REQUEST. The type of data provided in the signal REQUEST and/or the signal SOURCE may be varied according to the design criteria of a particular implementation.

The role enforcement system 150 may receive the signal REQUEST and/or the signal SOURCE. For example, the signal REQUEST may be received from one of the client devices 52a-52n. The signal REQUEST may be presented to the AI engine 80 and the governance layer 100. In some embodiments, the governance layer 100 may intercept the signal REQUEST and then forward the signal REQUEST to the AI engine 80. The signal SOURCE may be presented to the governance layer 100. In some embodiments, the signal SOURCE may be provided by the client device 52. In some embodiments, the governance layer 100 may receive the signal SOURCE from the authoritative data source 54 (e.g., in response to a request made by the governance layer 100 to the authoritative data source 54). Whether the signal SOURCE is provided by the client devices 52a-52n, the authoritative data source 54 and/or another source may be varied according to the design criteria of a particular implementation.

In one example, the signal SOURCE may be provided by the authoritative data source 54. In another example, the signal SOURCE may be provided by the client devices 52a-52n. For example, the client devices 52a-52n may provide the signal SOURCE comprising a pre-defined data segment. The pre-defined data segment may comprise a selection of text that may be intended by the end user to be reproduced by the AI engine 80 word for word. In one example, the pre-defined data segment may comprise text from a citation (e.g., a legal citation, a citation from an article, a quotation from a speaker, an MLA citation, etc.).

In some embodiments, the signal SOURCE may be data stored in a closed system. For example, the authoritative data source 54 may comprise storage for a closed system. In one example, the closed system may be a repository for medical records. In another example, the closed system may be a repository for police evidence. In yet another example, the closed system may be government records. Generally, for the authoritative data source 54 implemented as a closed system, the authoritative data source 54 may have limited access (e.g., no external access from outside the closed system, accessible externally only using an API, accessible using pre-defined credentials, etc.). The governance layer 100 may maintain a designation record identifying the authoritative data source 54 for the closed system as being an authoritative source for predefined semantic roles (e.g., data retrieved from the authoritative data source 54 may be deemed authoritative and/or may be stored in a fixed buffer). The governance layer 100 may be configured to prevent probabilistic substitution by the AI engine 80 for the authoritative data. In some embodiments, the governance layer 100 may prevent execution by the AI engine 80 when the authoritative data source 54 is not accessible (e.g., the data source cannot be retrieved from the closed system).

In some embodiments, the authoritative data source 54 may be a third party data source (e.g., a website, a library archive, a newspaper archive, a digital encyclopedia, etc.). In one example, the authoritative data source 54 may be specifically identified by the client devices 52a-52n with the signal REQUEST (e.g., requesting professional athletic statistics from espn.com). In another example, the authoritative data source 54 may be a government resource (e.g., a website that provides up-to-date government rules, laws, regulations, building codes, etc.). In some embodiments, the governance layer 100 may be configured to determine and/or store a trust level ranking for the authoritative data source 54 (e.g., multiple websites may be accessible for accessing data, each with varying levels of reliability). For example, the trust level may be used to determine which website to access as the authoritative data source 54. In some embodiments, the governance layer 100 may be configured to generate a question comprising a list of available resources for the end user. The end user may select the desired resource from the list provided in the question, and the governance layer 100 may use the selection as the authoritative data source 54 (e.g., in a request for hockey statistics, the governance layer 100 may provide a question listing nhl.com, tsn.ca, and espn.com as available options). The particular method of determining the data source may depend on the available access to external systems, the information provided in the request, the available third party sources, etc. and may be varied according to the design criteria of a particular implementation.

The signal REQUEST may comprise the structured output template 152. The structured output template 152 may be a format and/or template for the output. For example, the end user may ask the AI engine 80 to provide output in a particular format along with asking for information and/or data. The structured output template 152 may be provided to guide the AI engine 80 to provide output into a desired format.

The structured output template 152 may comprise components 160a-160n and/or 162a-162n. The components 160a-160n may comprise structural components. The components 162a-162n may comprise semantic roles. The structural components 160a-160n may comprise a portion of the structured output template 152 that may provide support, narrative content and/or context for the semantic roles 162a-162n. The semantic roles 162a-162n may comprise parameters that may be filled in. The structural components 160a-160n and/or the semantic roles 162a-162n may be generated by the AI engine 80.

Generally, the structural components 160a-160n may be content that may be populated by probabilistically generated content from the AI engine 80 (e.g., analytical and/or explanatory functions). The role enforcement system 150 enabled by the governance layer 100 may restrict one or more of the semantic roles 162a-162n from being populated by the probabilistically generated content. For example, in response to a question provided by the signal REQUEST, for the structural components 160a-160n, the AI engine 80 may generate an answer, but for some of the semantic roles 162a-162n (e.g., semantic roles identified as an authoritatively bound role), the AI engine 80 may generate an answer that may be locked to verified data (e.g., from the authoritative data source 54) by the governance layer 100.

In one example, for the structured output template 152 that provides medical information, the structural components 160a-160n may comprise headings and/or additional information and the associated semantic roles 162a-162n may comprise values (e.g., the structural component 160a may comprise “the patient has a weight of:” while the associated semantic role 162a may comprise “200 lbs”). In another example, for the structured output template 152 that provides sports statistics, the structural components 160a-160n may comprise headings and/or additional information and the associated semantic roles 162a-162n may comprise statistical values (e.g., the structural component 160a may comprise “the leading scorer in the NHL had:” and the structural component 160b may comprise “the best goalie in the NHL had:” while the associated semantic role 162a may comprise “50 goals” and the associated semantic role 162b may comprise “2.19 GAA”). In yet another example, for a financial transaction recommendation generated by a particular person, the structural components 160a-160n may comprise various justifications for making or not making a purchase, and the semantic roles 162a-162n may comprise particular investments and/or current values of the investments. The particular type of structural components 160a-160n and/or the semantic roles 162a-162n may be varied according to the design criteria of a particular implementation.

The governance layer 100 may be configured to analyze the information in the signal REQUEST. In some embodiments, the signal SOURCE may be provided by the client device 52 with the signal REQUEST. In some embodiments, the governance layer 100 may comprise one or more components configured to analyze the input to determine whether to access the authoritative data source 54. To retrieve information from the authoritative data source 54, the governance layer 100 may generate a signal (e.g., REQ). The authoritative data source 54 may provide the signal SOURCE in response to the signal REQ. Details for determining whether to access the authoritative data source 54 may be described in association with FIG. 3.

The governance layer 100 may comprise the token sequencer 102, a block (or circuit) 180, a block (or circuit) 182 and/or a block (or circuit 184. The circuit 180 may implement a role identification module. The circuit 182 may implement a constraint validation module. The circuit 184 may implement an assembly module. The governance layer 100 may comprise other components (not shown). For example, additional components implemented by the governance layer 100 may be described in association with FIG. 3. The number, type and/or arrangement of the components of the governance layer 100 may be varied according to the design criteria of a particular implementation.

The role identification module 180 may be one component of the governance layer 100. The role identification module 180 may be configured to receive and/or parse the signal REQUEST. The role identification module 180 may be configured to determine which content in the structured output template 152 may be the structural components 160a-160n and/or the semantic roles 162a-162n. The role identification module 180 may be configured to determine which of the semantic roles 162a-162n may be classified as an authoritatively bound role. For example, some of the semantic roles 162a-162n may be required to be filled in with particular data types, but may be filled in with general values and/or values that may not necessarily need to be precise, while some of the semantic roles 162a-162n may be required to be filled in with particular data types, but may be required to be precise content from a verified data source. In an example, one of the semantic roles 162a-162n may be a weight value that may be required to be provided in units of pounds, but providing an exact and/or precise value may not be beneficial (e.g., approximately 200 lbs may be acceptable, even if a person actually weighs 198 lbs). In another example, one of the semantic roles 162a-162n may be known allergies of a patient, which must be cited accurately from a data source.

In some embodiments, the structured output template 152 may comprise an indication of which of the content in the structured output template 152 may be the semantic roles 162a-162n and/or which of the semantic roles 162a-162n may be an authoritatively bound role. For example, the signal REQUEST may ask in plain language that the AI engine 80 (e.g., the governance layer100 may be transparent to the end user) provide a general description of a patient and list the known allergies of the patient, and may indicate that the patient name and the allergies be cited precisely from the medical record. In response to the signal REQUEST, the role identification module 180 may identify that the end user requested that the name and the allergies may be the semantic roles 162a-162n that may be authoritatively bound, while the general description of the patient may be the structural components 160a-160n (e.g., the structural components 160a-160n may describe that the patient appears to be generally fit, while the semantic roles 162a-162n cite from the medical record that the patient is named John Smith and has an allergy to penicillin). In some embodiments, the role identification module 180 may be configured to analyze the structured output template 152 to determine which content may be structural components 160a-160n and which content may be semantic roles 162a-162n. For example, the role identification module 180 may store particular data types that may be known to be semantic roles 162a-162n and/or authoritatively bound roles. In one example, for a NHL player, the authoritatively bound roles identified by the role identification module 180 may be stored as a lookup table comprising, goals, assists, points, penalty minutes, games played, shots, faceoff wins, time on ice, powerplay goals, shorthanded goals, game winning goals, etc.

In some embodiments, the role identification module 180 may be configured to define role attributes for the authoritatively bound roles. The role attributes may be determined in response to the context of the semantic roles 162a-162n. The role attributes may indicate particular categories for the authoritatively bound roles. For example, some of the authoritatively bound roles may comprise data that may rarely change, data that may be continually evolving and/or conditional data. For example, for statistical data for an athlete, data from completed seasons may not change. In another example, a currency exchange rate may evolve regularly. The particular types of the role attributes identified for the semantic roles 162a-162n and/or the authoritatively bound roles by the role identification module 180 may be varied according to the design criteria of a particular implementation.

The role identification module 180 may be configured to generate a signal (e.g.,

CDVAL) and/or a signal (e.g., RATTR). The signal CDVAL may comprise candidate values. The signal RATTR may comprise the authoritatively bound roles and/or the role attributes for the authoritatively bound roles. The signal CDVAL and/or the signal RATTR may be presented to the AI engine 80 and/or the constraint validation module 182. For example, constraint validation may be an optional feature provided by the governance layer 100. The signal CDVAL and/or the signal RATTR may be generated by the role identification module 180 in response to the structured output template 152 provided in the signal REQUEST and/or the signal SOURCE.

The candidate output may comprise natural language text, structured data elements, and/or a combination of both natural language and structured data elements. The candidate output may comprise semantic units that may correspond to discrete informational assertions and/or parameter values contained within the generated content. A semantic unit may comprise a phrase, clause, sentence fragment, structured field value, etc. of generated output that may convey a particular factual and/or inferential meaning. The semantic units may be generated in a machine-readable format that may enable the governance layer 100 to analyze the content of the generated output independently of the AI engine 80. In some embodiments, a semantic unit may be represented as a data structure comprising the extracted textual content together with associated metadata describing attributes of the semantic unit. The metadata may comprise the position of the semantic unit within the generated output, references to source material from which the semantic unit may have been derived, confidence scores generated by the AI engine 80, epistemic classifications identifying whether the semantic unit corresponds to retrieved information or inferred reasoning, etc.

The role identification module 180 may be configured to identify lifecycle behavior for the parameters used in generative reasoning systems. For example, for the semantic roles 162a-162n, the role identification module 180 may determine attributes for the authoritatively bound roles. The role attributes (e.g., provided in the signal RATTR) may provide practical limitations for the semantic roles 162a-162n. For example, some roles may represent stable attributes that rarely change, others may represent parameters that must be retrieved in real time to ensure currency, and still others may become relevant only when certain contextual conditions are present. In an example, in pediatrics, weight-based dosing may be used unless the patient is morbidly obese. When a patient is morbidly obese, dosing may be determined according to lean body weight to prevent overdose. The lean body weight may be a conditional role attribute (e.g., conditional upon obesity), while the weight may be a dynamic role attribute (e.g., required to be current). In another example, a static role attribute may be an archived value, such as statistics for an athlete from seasons that have been completed, while the dynamic role attribute may be a current value such as a particular statistic for the athlete from the current (e.g., ongoing) season. In yet another example, dynamic role attributes may be used for patient allergies and/or current medications. The role identification module 180 may not only classify the semantic roles 162a-162n according to the authoritative data source but also according to lifecycle role attributes governing when and how those roles must be resolved.

In some scenarios, the signal CDVAL may be suitable output for the structured output template 152. In some scenarios, the signal CDVAL may be unsuitable for the structured output template 152. The signal CDVAL may provide a candidate value for validation and the signal RATTR may provide information about the authoritatively bound role as a basis for validation. The signal CDVAL and/or the signal RATTR may be presented to the constraint validation module 182.

The constraint validation module 182 may be a component of the governance layer 100. The constraint validation module 182 may be configured to receive the signal CDVAL and/or the signal RATTR. The constraint validation module 182 may be configured to evaluate whether the candidate values in the signal CDVAL may satisfy one or more validation constraints. The validation constraints may be pre-defined parameters and/or parameters determined according to the semantic roles 162a-162n and/or the authoritatively bound role(s). For example, one or more of the validation constraints may be determined in response to the signal CDVAL and/or the signal RATTR. The validation constraints may ensure that candidate values may be acceptable for the semantic roles 162a-162n and/or the authoritatively bound roles. The validation constraints may prevent the AI engine 80 from filling the content for the semantic roles 162a-162n identified as the authoritatively bound roles using content that may have been probabilistically generated. The validation constraints may override probabilistic inference. The validation constraints may enforce completion conditions for the structured output template 152. In some embodiments, the constraint conditions may be defined by the authoritatively bound roles data and/or the role attributes provided by the role identification module 180. The particular constraint conditions may be varied according to the design criteria of a particular implementation.

The validation constraints that may be applied to an authoritatively bound role may not necessarily be fixed and may vary depending on the particular semantic roles 162a-162n being populated and/or the characteristics of the associated authoritative data source. In some embodiments, the constraint validation module 182 may associate different validation rules with different types of semantic roles in order to ensure that the retrieved parameter value for the candidate values may be suitable for use in the generated output. In one example, validation constraints for a numerical parameter may comprise range checks and/or plausibility verification. In another example, validation constraints for temporal data may comprise a confirmation that the retrieved value is current.

In some embodiments, the validation constraints may verify that the retrieved content matches an authoritative record, satisfies a defined format, corresponds to a recognized identifier, etc. The validation process may be role-specific and/or may be selected dynamically based on the semantic role and the authoritative data source from which the candidate value is retrieved. For example, the particular validation constraints may depend on the semantic roles 162a-162n and the data source (e.g., determined from the signal CDVAL and/or the signal RATTR). While some of the validation constraints may overlap for each of the authoritatively bound roles, generally each of the authoritatively bound roles may have individual and/or distinct validation constraints that may be appropriate for the type of parameter being enforced. The specific validation constraints applied to a given role may depend on the nature of the parameter, the characteristics of the authoritative data source, the requirements of the downstream process 56, etc. In one example, for a medical system, a patient weight parameter may be validated by confirming that the value falls within physiologically plausible limits and corresponds to a recent chart entry. In another example, for a player statistic retrieved from a sports database, the parameter may be validated by confirming that the value corresponds to an official league record. In yet another example, for a financial transaction, parameters such as account balances may be validated to ensure that the retrieved value reflects the most recent transaction state. The validation constraints may comprise format and/or structural checks. For example, for a legal citation, the parameter may be validated by confirming that the retrieved text matches the official language stored in a legal database. The particular validation constraints for each type of the semantic roles 162a-162n and/or the authoritatively bound role(s) may be varied according to the design criteria of a particular implementation.

The governance layer 100 may generate a signal (e.g., ABR). In some embodiments, the signal ABR may be generated by the governance layer 100 without performing constraint validation. In some embodiments, the constraint validation module 182 may generate the signal ABR after performing the constraint validation. The signal ABR may comprise populated authoritatively bound content and/or valid output (e.g., governed output). In some embodiments, the signal ABR may be generated in response to the signal REQUEST and the signal SOURCE. For example, when the governance layer 100 is implemented without the constraint validation module 182, the signal ABR may comprise the candidate values retrieved from the authoritative data source 54. In some embodiments, the signal ABR may be generated by the constraint validation module 182 in response to evaluating the candidate values in the signal CDVAL and/or the role attributes in the signal RATTR. The signal ABR may be presented to the token sequencer 102. The signal ABR may comprise the authoritatively bound role(s) that have been populated with values by the governance layer 100.

In some embodiments, the constraint validation module 182 may block output to the AI engine 80. In one example, when constraint validation fails, the signal ABR may not be presented to the token sequencer 102 and then forwarded to the AI engine 80. For example, since the authoritatively bound role cannot be satisfied due to the validation failure, the governance layer 100 may prevent the AI engine 80 from generating output (e.g., for some scenarios, no output may be better than the AI engine 80 hallucinating output). In one example, for a closed system for a medical system portal that receives medical prescription information, if the medical record cannot be accessed and/or required information is missing from the medical record, then no prescription may be generated. In some embodiments, the constraint validation module 182 may enable the governance layer 100 to attempt to retrieve more accurate data from the authoritative data source 54 (or attempt a different data resource). For example, for a request about athletic statistics, if the one resource is unavailable or is lacking information from the current season, the constraint validation module 182 may generate a request from another resources (e.g., nhl.com may be unavailable, but espn. com may be used as an alternate to receive another set of candidate values for the authoritatively bound role).

The signal ABR may be presented to the token sequencer 102 along with the signal REQUEST. The governance layer 100 may provide the signal ABR comprising the populated authoritatively bound role(s) to the token sequencer 102. The token sequencer 102 may generate a signal (e.g., AWT). The signal AWT may be generated by the token sequencer 102 in response to the signal ABR and/or the signal REQUEST. The token sequencer 102 may be configured to condition the tokens of the input (e.g., the signal REQUEST) and the tokens for the authoritatively bound role(s) (e.g., the signal ABR). The signal AWT may comprise a conditioned version of the authoritatively bound role(s) and/or a conditioned version of the input request. In one example, the signal AWT may comprise a positional precedence and/or overweight values for the authoritatively bound role(s). In an example, the token sequencer 102 may be configured to establish positional precedence for the authoritatively bound role(s). The signal AWT may be presented to the AI engine 80 (e.g., a generative machine learning system) as part of an execution context for generating the structured output 154. The signal ABR may provide read-only data for the semantic roles 162a-162n. The AI engine 80 may be configured to generate a signal (e.g., PR-FL) in response to the signal AWT. The signal PR-FL may comprise probabilistically inferred content generated by the AI engine 80. The signal PR-FL may further comprise positional information for the authoritatively bound role(s). In an example, the signal PR-FL may comprise the probabilistically inferred content generated by the AI engine 80 in addition to positional information (e.g., positional flags, a placeholder marker, a reserved token, a low-confidence token, etc.) generated based on the positional information provided in the signal AWT. The positional information may enable the governance layer 100 to reconstruct and/or assemble the authoritatively bound roles in the context of the probabilistically inferred content of the signal PR-FL.

The signal PR-FL may comprise probabilistic inferences generated by the AI engine 80 for the structural components 160a-160n and/or the semantic roles 162a-162n. In some embodiments, the signal AWT may be passed through by the AI engine 80 to fill the semantic roles 162a-162n that are authoritatively bound and the signal PR-FL may comprise inferred content that may be used to generate remaining content to fill the structured output template 152. In another example, the signal AWT may be used as read-only content corresponding to the authoritatively bound role(s) (e.g., a deterministic parameter) that the AI engine 80 may build a response around (e.g., make inferences based on the fixed data for the authoritatively bound role). In one example, for a request asking about the best athlete of all time, the statistics (e.g., goals, points, number of championships won, number of individual awards won, etc.) may be authoritatively bound data, while the subjective portion may be probabilistically inferred by interpreting the statistics (e.g., most points or most individual awards may provide a basis for deciding which player is best, but who is best may still be debatable). The AI engine 80 may be permitted to infer values for the semantic roles 162a-162n other than the authoritatively bound roles. In one example, the AI engine 80 may generate narrative content (e.g., the structural components 160a-160n) that references the authoritatively bound role(s) and the governance layer 100 may prevent modification of the authoritatively bound roles that have been populated and/or may assemble the authoritatively bound roles in response to the signal PR-FL. The amount of content that may be probabilistically inferred and provided as output along with the populated authoritatively bound role(s) may be varied according to the design criteria of a particular implementation.

The signal AWT may provide the input (e.g., tokenized content generated by the token sequencer 102 in response to the signal REQUEST) that the AI engine 80 may use to generate output. For example, the signal REQUEST may ask the AI engine 80 to analyze a document (e.g., a text file such as a medical record), and the end user may provide the document as the signal SOURCE. In another example, the signal SOURCE may be received from the authoritative data source 54 by the governance layer 100. In one example, the signal REQUEST may ask the AI engine 80 to search a medical record for a patient, and the governance layer 100 may request the medical record from the authoritative data source 54 to provide the populated authoritatively bound roles. In another example, the signal REQUEST may ask the AI engine 80 to find the top 10 goalies according to save percentage from the website nhl.com and the governance layer 100 may request data from the website to provide the populated authoritatively bound roles to the AI engine 80.

The signal PR-FL may be received by the governance layer 100. For example, the AI engine 80 may generate the signal PR-FL comprising the probabilistically inferred content in addition to the positional information for the authoritatively bound role(s) and the signal PR-FL may be provided as feedback to the governance layer 100. The signal PR-FL may be received by the assembly module 184.

The assembly module 184 may be configured to receive the signal PR-FL and/or the signal ABR. The assembly module 184 may be configured to assemble the governed output (e.g., generate the signal GOV) in response to the signal PR-FL and/or the signal ABR. The signal GOV may be the output of the governance layer 100. The assembly module 184 may generate the governed output by inserting and/or assembling the authoritatively bound roles into the output of the AI engine 80. For example, the signal PR-FL may comprise the positional information that may be analyzed by the assembly module 184. The assembly module 184 may analyze the positional information to determine where and which of the authoritatively bound roles may be combined with the probabilistically inferred content. The assembly module 184 may ensure that the governed output comprises the authoritatively bound roles. In one example, the assembly module 184 may retrieve one or more of the authoritatively bound roles stored in a memory (e.g., a fixed buffer that may be inaccessible and/or not writable to by the AI engine 80).

The structured output 154 may be provided by the signal GOV. The structured output 154 may be populated with content generated by the AI engine 80 in response to the signal AWT. In an example, the operation of the governance layer 100 may be transparent to the end-user. For example, the end user may provide the signal REQUEST to the cloud computing service 58 in order to use the AI engine 80 and the end user may receive the signal GOV comprising the structured output 154 in response. The governance layer 100 may intercept the signal REQUEST, retrieve the authoritative data in the signal SOURCE, generate the authoritatively bound role(s) and generate the signal AWT to enable the AI engine 80 to generate the probabilistically inferred content. Then the governance layer 100 may receive the signal PR-FL and assemble the authoritatively bound content with the probabilistically inferred content and provide the governed output. Whether the end user has knowledge of the operations performed by the governance layer 100 may be varied according to the design criteria of a particular implementation.

The structured output 154 may comprise filled structural components 160a′-160n′ and/or validated semantic roles 190a-190n. One or more of the validated semantic roles 190a-190n may be a populated authoritatively bound role 200. In the example shown, there may be one populated authoritatively bound role and the validated semantic role 190a may be the populated authoritatively bound role 200. In some embodiments, any one of the validated semantic roles 190a-190n or more than one of the validated semantic roles 190a-190n may be populated authoritatively bound role 200 (e.g., there may be more than one populated authoritatively bound role). The number of populated authoritatively bound roles and/or which of the validated semantic roles 190a-190n may be the populated authoritatively bound role 200 may be varied according to the design criteria of a particular implementation.

The filled structural components 160a′-160n′ may be generated comprising the probabilistically generated content. The filled structural components 160a′-160n′ may be filled in by the AI engine 80 based on and/or using the values provided in the signal AWT to provide narrative context. The validated semantic roles 190a-190n may be filled in by the AI engine 80 using the probabilistically generated content and/or the authoritative content that may have been validated by the constraint validation module 182 depending on which of the validated semantic roles 190a-190n have been identified as the authoritatively bound roles. The structured output 154 may comprise a combination of one or more populated authoritatively bound roles and probabilistically generated content produced by the AI engine 80. In some embodiments, the AI engine 80 may generate the validated semantic roles 190a-190n probabilistically, even for the validated semantic roles 190a-190n flagged as the authoritatively bound roles. The assembly module 184 may replace the validated semantic roles 190a-190n flagged as the authoritatively bound role to provide the populated authoritatively bound role 200.

The downstream process 56 may be configured to receive the signal GOV. The signal GOV may comprise the structured output 154 generated by the AI engine 80 and assembled by the governance layer 100 (e.g., a combination of the populated authoritatively bound roles in the signal ABR and the probabilistically inferred content in the signal PR-FL). The downstream process 56 may provide one or more processes and/or actions in response to the structured output 154.

The populated authoritatively bound role 200 (e.g., a deterministically bound role) may be content that may be an output provided by a canonical source. The role enforcement system 150 may ensure that the populated authoritatively bound role 200 comprises output that may be determined according to an authority of values. The role enforcement system 150 may not necessarily determine how the AI engine 80 generates probabilistically inferred content. The role enforcement system 150 may ensure that particular fields of the structured output 154 come from the authoritative data source, regardless of what the AI engine 80 might otherwise generate. The validated semantic roles 190a-190n that correspond to the authoritatively bound roles identified by the role identification module 180 in response to an analysis of the semantic roles 162a-162n may be supplied deterministically from the data source rather than inferred probabilistically by the AI engine 80. The filled structural components 160a′-160n′ may be narrative and/or reasoning content that may be generate probabilistically by the AI engine 80. The validated semantic roles 190a-190n that correspond to the populated authoritatively bound role 200 may comprise output that may be values that must come from a verified data source. The populated authoritatively bound role 200 may be bound to authoritative data and not to the generative process implemented by the AI engine 80. The token sequencer 102, the role identification module 180, the constraint validation module 182 and/or the assembly module 184 may enforce data output binding that may prevent the AI engine 80 from inventing (e.g., hallucinating) a value.

The authoritatively bound roles may be one or more of the semantic roles 162a-162n that may be supplied values that must be retrieved from an authoritative data source, must satisfy validation rules and cannot be populated by probabilistic generation. The authoritatively bound roles may be satisfied when the output (e.g., the populated authoritatively bound role 200) is bound to an authoritative data source or has a value deterministically retrieved from a data source. The role identification module 180 may identify an authoritatively bound role among the one or more predefined semantic roles 162a-162n (e.g., which of the validated semantic roles 190a-190n may be the populated authoritatively bound role 200 in the structured output 154). The governance layer 100 may retrieve a parameter value associated with the authoritatively bound role. The constraint validation module 182 may prevent probabilistically generated content from populating the authoritatively bound role. The token sequencer 102 may tokenize the authoritative value for the authoritatively bound role. The assembly module 184 may combine the authoritative value(s) with the probabilistically inferred content generated by the AI engine 80. The governance layer 100 may ensure that the authoritatively bound role may be a semantic role with a value that must be supplied from an authoritative data source rather than through probabilistic generation by the AI engine 80.

The role enforcement system 150 may implement a governance layer that may enforce rules before an AI system is allowed to produce or use an answer. The AI engine 80 may be a system such as a LLM that generates text and/or answers (e.g., ChatGPT, Claude, Gemini, a hospital AI assistant, an automated legal drafting tool, etc.). The input may comprise a request such as “generate a prescription for patient X”, or “draft a treatment plan for patient X”. The structured output template 152 may comprise an output that may comprise specific fields and/or slots, rather than purely free text. For example, the semantic roles 162a-162n for the structured output template 152 may comprise a drug, a dosage, a patient weight, blood pressure, a surgery date, a contact name, etc. The authoritatively bound roles may be the semantic roles 162a-162n that must come from verified data (e.g., without the AI engine 80 “guessing”). For example, dosing may be the populated authoritatively bound role 200 that may come from dosing rules. The candidate values may comprise retrieved values for the semantic roles 162a-162n. For example, the candidate values may comprise ‘Patient weight=82 kg’, ‘Creatinine level=1.3’, ‘Blood pressure=140/90’, etc. The authoritative data source may be a trusted database and/or record that the role enforcement system 150 may treat as ground truth. The authoritative data source may be provided as the signal SOURCE. In an example, the authoritative data source may be one or more of an electronic medical record (EMR), a hospital lab system, a financial database, legal document repository, a government registry, etc. The validation constraints may be rules that may be used to confirm that the candidate values are acceptable. For example, the validation constraints may be associated with data freshness (e.g., lab results from with the last 24 hours), completeness (e.g., a dosage value may not be missing), consistency (e.g., weight and dosage must be consistent with dosing rules, etc.), etc. Probabilistically generated content may be content that the AI engine 80 may be most likely to use to predict an answer. For example, if the medical record does not have a patient weight listed, the AI engine 80 may use an average adult weight. The role enforcement system 150 may forbid the AI engine 80 from using inferred content for the authoritatively bound roles. The constraint validation module 182 may forbid the AI engine 80 from proceeding until the roles are filled correctly (e.g., the prescription may not be filled until the patient allergies are verified). The token sequencer 102 may ensure that the AI engine 80 provides the probabilistically inferred content comprising positional information that may be used by the assembly module 184. The assembly module 184 may ensure that the populated authoritatively bound role 200 is in the governed output. The role enforcement system 150 may force particular critical fields to be filled using verified data instead of guessing by the AI engine 80, and may prevent the system from executing anything until the particular fields are validated.

The role enforcement system 150 may pre-declare the required semantic roles semantic roles 162a-162n for the structured output template 152 that the AI engine 80 may fill in (e.g., weight, dosage, contract party, account number, etc.). The role enforcement system 150 may bind the semantic roles 162a-162n to authoritative sources and the governance layer 100 may retrieve values from the authoritative data source 54 (e.g., (databases, records, supplied documents, other verified systems, etc.). The role enforcement system 150 may override probabilistic content generation by the AI engine 80. For example, if a valid value cannot be retrieved and/or validated the role enforcement system 150 may prevent action by the downstream process 56. The role enforcement system 150 may be used for medical orders, financial transactions, legal filings, compliance systems, automated document generation, autonomous agent workflows, etc.

In one example, a hospital may use an AI assistant with the role enforcement system 150 to generate prescriptions. The doctor may provide the input (e.g., the signal REQUEST) with a prompt of “generate an order for Vancomycin for this patient”. The signal REQUEST may further comprise the structured output template 152 (or the structured output template 152 may be previously stored) that provides semantic roles 162a-162n that may comprise “Drug:”, “Dose:”, “Patient weight:”, “Frequency:”, “Allergies:”, etc. The semantic roles 162a-162n may be filled in by the AI engine 80. The role identification module 180 may identify which of the semantic roles 162a-162n may not be guessed. For example, the allergies and/or the patient weight may not be guessed (e.g., dosing depends on the patient weight and allergies). The AI engine 80 and/or the governance layer 100 may access the authoritative data source 54 comprising a medical record and retrieve the patient weight (e.g., 82 kg), allergies and/or other information. The constraint validation module 182 may review candidate values generated by the AI engine 80 to check the validation constraints. For example, the constraint validation module 182 may check whether the weight has been recorded in the last 24 hours, whether recent allergies have been listed, whether other medications are being taken, whether the units are valid, etc. If the validation is accepted, the values may be used. The assembly module 184 may insert the populated authoritatively bound role 200 into one or more of the validated semantic roles 190a-190n to provide the structured output 154 that may be bound to an authoritative source. For example, the downstream process 56 may generate a prescription comprising “Drug: Vancomycin”, “Weight: 82 kg”, “Dose: 1250 mg”, etc. The role enforcement system 150 may prevent the downstream process 56 from receiving an incomplete data set such as a missing weight, missing allergies, etc. The role enforcement system 150 may prevent a typical adult weight (e.g., probabilistically inferred by the AI engine 80) from being provided instead of the actual weight. The constraint validation module 182 may stop the prescription, insert a placeholder, request a new measurement, escalate the scenario to a doctor, etc.

Referring to FIG. 3, a block diagram illustrating a memory buffer architecture for a governance layer is shown. A governance layer architecture 250 is shown. The governance layer architecture 250 may comprise the client device 52, the authoritative data source 54, the downstream process 56, the AI engine 80, the governance layer 100, and/or the structured output 154. In the example shown, the governance layer architecture 250 may be implemented as an output-side governance layer.

The client device 52 may be a representative example of one of the client devices 52a-52n described in association with FIG. 1. Generally, the client device 52 may generate the signal REQUEST and/or the signal SOURCE. In the example shown, the client device 52 may not receive an input and may provide the signal REQUEST. In some embodiments, the AI engine 80 may provide output back to the client device 52. For example, a web interface executed by the client device 52 may enable the end user to provide the structured output template 152 to the AI engine 80, and the AI engine 80 may provide responses to the input (e.g., a conversational interface) that may be provided as the structured output 154 back to the client device 52 (e.g., the operations of the governance layer 100 may be transparent to the end user). In some embodiments, the client device 52 may enable the end user to provide the input signal REQUEST and/or the data source signal SOURCE to the AI engine 80, and the governance layer 100 may provide output to downstream devices and/or the downstream process 56 (e.g., the client device 52 may request data such as the latest deals provided by a business, and the governance layer 100 may communicate the output response to a number of kiosk displays throughout the business). The number, type and/or format of the signals generated by and/or received by the client device 52 may be varied according to the design criteria of a particular implementation.

The client device 52 may provide the input signal REQUEST to the governance layer 100. The authoritative data source 54 may receive the signal REQ from the governance layer 100. The authoritative data source 54 may provide the input signal SOURCE to the governance layer 100. For example, the authoritative data source 54 may provide the signal SOURCE in response to the signal REQ. The AI engine 80 may receive the signal AWT from the governance layer 100. For example, the governance layer 100 may be configured to forward the input request from the client device 52 to the AI engine 80 as part of the signal AWT. The AI engine 80 may provide the input signal PR-FL to the governance layer 100. The downstream process 56 may receive the output signal GOV from the governance layer 100. The output signal GOV may comprise the structured output 154. Other input/output signals may be received by and/or output by the governance layer 100. The particular number, type and/or format of the signals communicated by the governance layer 100 may be varied according to the design criteria of a particular implementation.

The governance layer 100 may comprise the token sequencer 102, the role identification module 180, the constraint validation module 182, the assembly module 184, a block (or circuit) 252, a block (or circuit) 254 and/or a block (or circuit) 256. The circuit 252 may implement a data retrieval module. The circuit 254 may implement a request conditioner. The circuit 256 may implement memory buffer. The governance layer 100 may comprise other components (not shown). The number, type and/or arrangement of the components implemented by the governance layer 100 may be varied according to the design criteria of a particular implementation.

The role identification module 180 may be configured to analyze the signal

REQUEST. The role identification module 180 may have a similar implementation as described in association with FIG. 2. The role identification module 180 may generate the signal RATTR in response to the signal REQUEST. For example, the role identification module 180 may identify authoritatively bound roles in the structured output template 152 in response to the signal REQUEST. The role identification module 180 may determine the authoritatively bound roles and/or the role attributes for the authoritatively bound roles. The signal RATTR may be presented to the data retrieval module 252 and/or the constraint validation module 182.

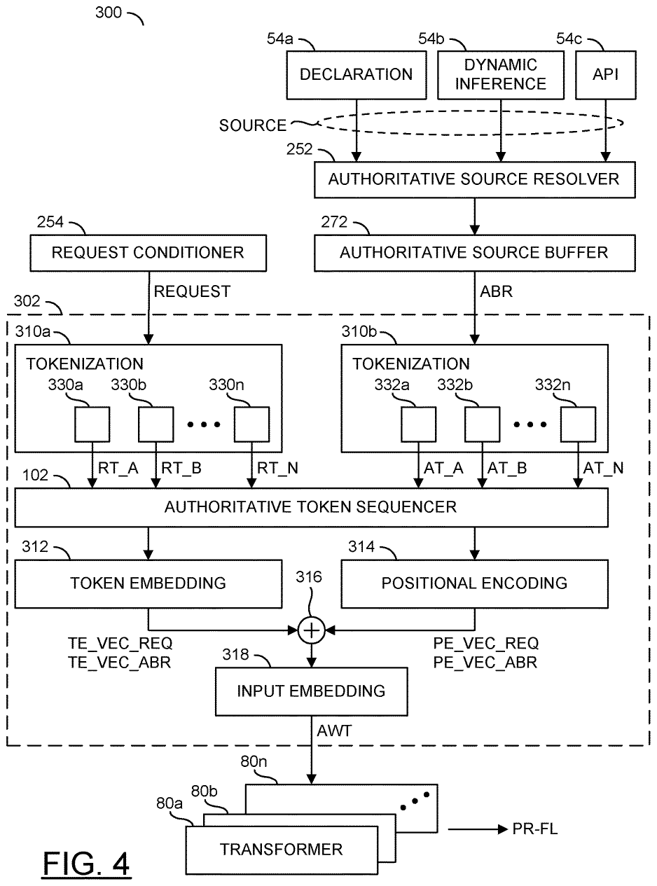

The data retrieval module 252 may receive the signal RATTR from the role identification module 180. The data retrieval module 252 may be configured to access the authoritative data source 54. For example, the data retrieval module 252 may be configured to generate the signal REQ to request information from the authoritative data source 54 and receive the signal SOURCE comprising the data retrieved by the authoritative data source 54. In some embodiments, the signal REQ may comprise login credentials for a closed system, API call data for the authoritative data source 54, a handshake protocol, etc. For example, the data retrieval module 252 may be configured to perform HTTP requests, API requests, provide login credentials, etc. In some embodiments, the data retrieval module 252 may comprise a list of trusted sources and/or a trust ranking for various data sources. In the example shown, the authoritative data source 54 is shown as an illustrative example of one or more available data resources. In some embodiments, the data retrieval module 252 may select one or more of the data sources 54a-54n (to be described in association with FIG. 4) based on a trust ranking and/or the role attributes for the authoritatively bound role(s). For example, the data retrieval module 252 may determine which sources may be a trusted source for the particular authoritatively bound role(s). The data retrieval module 252 may retrieve the candidate values from the authoritative data source 54. The data retrieved by the data retrieval module 252 (e.g., the candidate values) may be provided to the constraint validation module 182 for validation. The data retrieval module 252 may communicate the signal CDVAL to the constraint validation module 182 in response to the signal RATTR and the signal SOURCE.

The constraint validation module 182 may be configured to analyze the candidate value(s) in the signal CDVAL and/or the role attribute information for the authoritatively bound roles in the signal RATTR. The constraint validation module 182 may have a similar implementation as described in association with FIG. 2. The constraint validation module 182 may be configured to validate and/or verify the candidate values retrieved from the authoritative data source 54. Data that has been validated by the constraint validation module 182 may be stored in the memory buffer 256. The validated data used to generate the populated authoritatively bound role 200 may be provided to the memory buffer 256 via the signal ABR. The constraint validation module 182 may generate the signal ABR in response to the signal CDVAL and/or the signal RATTR.

The request conditioner 254 may be configured to perform an analysis and/or adjustment to the input request. The request conditioner 254 may receive the signal REQUEST. The request conditioner 254 may provide the signal REQUEST to the token sequencer 102. The request conditioner 254 may generate a signal (e.g., STATE). The signal STATE may comprise governance state information. The signal STATE may be provided to the memory buffer 256. Conditioning operations performed by the request conditioner 254 may be configured to ensure the structured output template 152 may be compatible with the token sequencer 102. The conditioning operations may be optional. For example, the request conditioner 254 may be an optional component. In some embodiments, the signal REQUEST may be provided to the token sequencer 102.

The request conditioner 254 may comprise a block (or circuit) 260, a block (or circuit) 262 and/or a block (or circuit) 264. The circuit 260 may implement a relevance detection module. The circuit 262 may implement a re-binding module. The circuit 264 may implement an objective evaluation module. The request conditioner 254 may comprise other components (not shown). The number, type and/or arrangement of the components of the request conditioner 254 may be varied according to the design criteria of a particular implementation.

The relevance detection module 260 may be configured to evaluate whether incoming content is relevant to the request context. In the example shown, the relevance detection module 260 may receive the signal REQUEST. However, the signal REQUEST may be received and/or analyzed by each component of the request conditioner 254. The relevance detection module 260 may be configured to perform an initial triage operation that may determine which portions of the input need governance processing versus pass-through to the token sequencer 102. For example, not every request from the client device 52 may benefit from authoritative governance. In one example, a casual conversational query may pass straight through to the AI engine 80 without governance processing by the governance layer 100. In some embodiments, the relevance detection module 260 may operate as a gate that may determine whether to enable governance. The relevance detection module 260 may generate data that may be provided as part of the signal STATE. The signal STATE may comprise a relevance determination and/or a relevance store generated by the relevance detection module 260. For example, the memory buffer 256 may store the relevance determination as part of a governance state.

The re-binding module 262 may be configured to re-bind evaluative conditions, maintain unresolved evaluative states as operative system states and/or perform re-binding with response override. The re-binding module 262 may be configured to handle situations where an authoritatively bound role may need to be re-associated with a different value and/or source. In one example, when a first candidate value fails validation (e.g., the constraint validation module 182 determines that the candidate value retrieved from the authoritative data source 54 by the data retrieval module 252 does not meet the validation constraints) and the governance layer 100 may try again with a different data source and/or a different binding. The re-binding module 262 may provide a mechanism that may prevent the governance layer 100 from being stuck when initial binding fails. The re-binding module 262 may enable iterative resolution. For example, the re-binding module 262 may enable the governance layer 100 to cycle through candidate values and/or sources until a candidate value satisfies validation constraints and/or determines that authoritative data is unavailable for the authoritative bound role(s). The re-binding module 262 may generate data that may be provided as part of the signal STATE. The signal STATE may comprise binding state data generated by the re-binding module 262.

The objective evaluation module 264 may be configured to evaluate governance constraints. The objective evaluation module 264 may evaluate whether the governance objective for a given request has been satisfied. The particular objective may be a goal state. For example, the objective evaluation module 264 may determine whether the governance layer 100 successfully ground the output in authoritative content where required. The operations of the objective evaluation module 264 may be distinct from the validation of the candidate values performed by the constraint validation module 182. The objective evaluation module 264 may operate at a level of the overall request outcome. The governance objective analyzed by the objective evaluation module 264 may determine whether the bindings that were achieved meet the requirements for the structured output template 152. The objective evaluation module 264 may generate data that may be provided as part of the signal STATE. The signal STATE may comprise the governance state evaluation generated by the objective evaluation module 264.

The operations performed by the relevance detection module 260, the re-binding module 262 and/or the objective evaluation module 264 may provide governance state information that may enable the governance layer 100 to track the status and/or overall operation of the governance layer 100. The governance state may be stored in the memory buffer 256. The governance state may be used to generate control signals (not shown) that may provide state information and/or enable/disable controls for the various components of the governance layer 100. The governance state information provided by the request conditioner 254 may be distinct from the input conditioning provided by the request conditioner 254. Details of the input conditioning may be provided in association with FIG. 4. The particular types of information provided by the governance state may be varied according to the design criteria of a particular implementation.

The memory buffer 256 may be configured to store data. The memory buffer 256 may store data corresponding to each of the input requests. For example, the memory buffer 256 may store the input request provided in the signal REQUEST and/or the populated authoritatively bound role(s) provided in the signal ABR. In one example, the memory buffer 256 may forward the input request from the client device 52 to the AI engine 80 (e.g., after the governance layer 100 has populated the authoritatively bound roles first by analyzing the request). In another example, the client device 52 may communicate the signal REQUEST to both the governance layer 100 and the AI engine 80. Generally, enabling the memory buffer 256 to forward the request to the AI engine 80 may enable the governance layer 100 to be transparent to the end user. In some embodiments, the memory buffer 256 may receive the signal PR-FL from the AI engine 80. For example, the memory buffer 256 may store the probabilistically inferred data generated by the AI engine 80. In some embodiments, the memory buffer 256 may communicate the signal ABR and/or forward the signal PR-FL to the assembly module 184. The number, type and/or format of the data signals communicated by the memory buffer 256 may be varied according to the design criteria of a particular implementation.

The memory buffer 256 may comprise a block (or circuit) 270, a block (or circuit) 272 and/or a block (or circuit) 274. The circuit 270 may implement an evaluative object store. The circuit 272 may implement a fixed buffer. The circuit 274 may implement a generative buffer. The memory buffer 256 may comprise other components (not shown). For example, the memory buffer 256 may comprise storage for the input request in the signal REQUEST. The number, type and/or arrangement of the components implemented by the memory buffer 256 may be varied according to the design criteria of a particular implementation.

The evaluative object store 270 may be configured to receive the signal STATE. The evaluative object store 270 may provide a central state container within the memory buffer 256. The evaluative object store 270 may store the governance state. For example, the evaluative object store 270 may receive governance state information from each of the relevance detection module 260, the re-binding module 262 and/or the objective evaluation module 264. The governance state stored by the evaluative object store 270 may be a persistence layer where the governance layer 100 may record what governance decisions were made, which bindings were established, which evaluations passed or failed, what the current state of the governance process is, etc. The evaluative object store 270 may store relevance determination as governance state, which may be used to enable/disable other operations. While the signal STATE is shown as an input received from the request conditioner 254, the evaluative object store 270 may provide the governance state information as output to the various components of the governance layer 100. In some embodiments, the governance state may control when the fixed buffer 272 and/or the generative buffer 274 are written to and/or read out from. For example, the governance state may control when the fixed buffer 272 provides output to the token sequencer 102 and/or the assembly module 184.

The fixed buffer 272 may be configured to receive the signal ABR. The fixed buffer 272 may store the populated authoritatively bound roles. For example, the fixed buffer 272 may receive the validated candidate values from the constraint validation module 182 that may populate the authoritatively bound roles. The fixed buffer 272 may be configured to store the validated semantic roles 190a-190n and/or content for the populated authoritatively bound role 200. The fixed buffer 272 may be configured to forward the information in the signal ABR to the token sequencer 102 and/or to the assembly module 184. The fixed buffer 272 may be read only by the AI engine 80. For example, the AI engine 80 may be forbidden from changing the data in the fixed buffer 272. The fixed buffer 272 may be writable to by the governance layer 100 (e.g., by the constraint validation module 182).

The fixed buffer 272 may store the validated data with read-only access permissions enforced with respect to the AI engine 80. In some embodiments, the AI engine 80 may reference the authoritative data provided by the authoritative data source 54 from the signal ABR stored in the fixed buffer 272 when generating the governed output. In some embodiments, the signal ABR may comprise a weight value. In one example, the weight value may be provided with a largest weight value usable by the AI engine 80 to prevent the AI engine 80 from changing the populated authoritatively bound roles stored in the fixed buffer 272. However, even with overweighting the authoritatively bound content, controlling and/or binding the output of the AI engine 80 may not ensure perfect effectiveness. For example, with severe overweighting, the binding of the output for the authoritatively bound roles may be limited to 90-95% effective (e.g., which may not be sufficient for critical tasks). The fixed buffer 272 may be configured to provide the signal ABR to the token sequencer 102 and/or the assembly module 184. Providing the signal ABR to the assembly module 184 may ensure that the structured output 154 may be bound to the populated authoritatively bound role 200. The particular method of preventing the AI engine 80 from changing the content stored in the fixed buffer 272 may be varied according to the design criteria of a particular implementation.

The generative buffer 274 may be configured to receive the signal PR-FL. The generative buffer 274 may be configured to store the probabilistically inferred content generated by the AI engine 80. The generative buffer 274 may be writeable to by the AI engine 80. For example, the generative buffer 274 may receive the probabilistically inferred content generated by the AI engine 80. The generative buffer 274 may be configured to store the filled structural components 160a'-160n′ and/or any of the validated semantic roles 190a-190n that have not been stored in the fixed buffer 272 (e.g., for the semantic roles that have not been identified as the authoritatively bound roles). The generative buffer 274 may be configured to forward the information in the signal PR-FL to the assembly module 184. Generally, the generative buffer 274 may be not writable by components of the governance layer 100 (e.g., the generative buffer 274 may be writable by the AI engine 80).

The token sequencer 102 may receive the signal ABR from the fixed buffer 272 and/or the signal REQUEST from the request conditioner 254. Generally, the token sequencer 102 may provide a tokenized version of the content stored in the fixed buffer 272 to the AI engine 80 and/or a tokenized version of the input request to the AI engine 80. The token sequencer 102 may generate the signal AWT in response to the signal ABR and/or the signal REQUEST. The token sequencer 102 may be configured to provide weighting adjustments to the authoritatively bound roles as input to the AI engine 80. For example, the token sequencer 102 may overweight the authoritatively bound roles to attempt to bias the AI engine 80 towards reproducing the populated authoritatively bound role 200 verbatim. In some embodiments, the AI engine 80 may not modify, paraphrase, reword, or otherwise alter the text and/or other content stored by the fixed buffer 272 (e.g., the AI engine 80 may generate output without substitution for the authoritatively bound roles). However, the reliability of overweighting may be insufficient for generating the structured output 154. The tokenization performed by the token sequencer 102 may enable the content from the input request and the authoritatively bound roles may be provided in the signal AWT in a format readable and/or compatible with the vocabulary of the AI engine 80.

In some embodiments, the overweighting performed by the token sequencer 102 may comprise positional preference information, a positional index, location flags, identified locations, placeholder markers, etc. The identified locations may enable the AI engine 80 to provide the probabilistically inferred content in the signal PR-FL with location information that may be usable by the assembly module 184 to insert the populated authoritatively bound role 200.

The probabilistically inferred content generated by the AI engine 80 may support, enhance and/or augment the populated authoritatively bound roles in the fixed buffer 272 but the governance layer 100 may ensure that the probabilistically inferred content may not alter the populated authoritatively bound role 200. The governance layer architecture 250 may prevent failure modes (e.g., altering, paraphrasing, misquoting, etc.) by storing the exact text in the fixed buffer 272 with read-only access permissions and by requiring the AI engine 80 to reference the fixed buffer 272 content without modification when generating all sections of the governed output and then re-inserting the populated authoritatively bound role 200 through assembly.

The governance layer architecture 250 may maintain two completely separate buffers (e.g., the fixed buffer 272 and the generative buffer 274) with no shared write access. The fixed buffer 272 may be populated by the governance layer 100 with authoritatively bound content before the AI engine 80 runs. The generative buffer 274 may receive output from the AI engine 80 only. The architectural components of the governance layer architecture 250 may be the fixed buffer 272 with read-only access permissions for the generative process, the generative buffer 274 that receives only model-generated content, a buffer controller implemented by the memory buffer 256 that may enforce the access permissions (e.g., prevents cross-buffer writes), the token sequencer 102 and/or the assembly module 184. The data stored in the fixed buffer 272 and the generative buffer 274 may be merged by the assembly module 184 according to the structured output template 152.

The assembly module 184 may receive the signal ABR and/or the signal PR-FL from the memory buffer 256. The assembly module 184 may be configured to combine the content from the fixed buffer 272 and the generative buffer 274 in correct structural positions to produce the final output (e.g., the governed output). The governed output of the assembly module 184 may be the structured output 154 provided in the signal GOV. In some embodiments, the signal GOV may be presented to the downstream process 56. The downstream process 56 may execute one or more actions in response to the structured output 154.

The assembly module 184 may be configured to perform post-inference token substitution. The assembly module 184 may be configured to read an output sequence of tokens, identify flagged positions for the tokens and generate the governed output comprising assembled tokens. The output sequence of tokens may comprise the output of the fixed buffer 272 and/or the generative buffer 274. In one example, the assembly module 184 may be configured to swap in, verbatim, the sequence of tokens of the populated authoritatively bound roles stored in the fixed buffer 272 into the output sequence of tokens of the generative buffer 274. For example, the probabilistically inferred sequence of tokens generated by the AI engine 80 in the signal PR-FL may comprise content for the authoritatively bound roles that may or may not necessarily be accurate (e.g., even with the overweighting information provided by the token sequencer 102) and the assembly module 184 may ensure accuracy by swapping out the tokens from the probabilistically inferred content with the tokens from the fixed buffer 272 into the flagged positions for the authoritatively bound roles.

The assembly module 184 may perform the token assembly outside of the operation(s) of a transformer and/or without providing input for a second pass to the transformer. The assembly module 184 may perform the assembly without involvement from a LLM. The assembly module 184 may perform a direct memory read from the fixed buffer 272 and perform a token-level string operations on the output sequence of tokens. Details of the token assembly performed by the assembly module 184 may be described in association with U.S. Provisional Application No. 64/026,578, filed on Apr. 2, 2026, appropriate portions of which are incorporated by reference. The particular method of token assembly performed by the assembly module 184 may be varied according to the design criteria of a particular implementation.

In one example, the fixed buffer 272 may comprise tokens corresponding to the authoritatively bound roles for athlete statistics (e.g., Player Name: Connor McDavid, Team: Edmonton, Number: 97, Games Played: 75, Goals: 43, Assists: 82, Points: 125, Penalty Minutes: 36, etc.) and/or a date of retrieval (e.g., a timestamp). The tokens in the fixed buffer 272 may be stored as a vector of values and/or in a matrix format. In the same example, the input request may comprise details about the best player currently in the NHL. The AI engine 80 may generate narrative content about the best player in the NHL. The narrative content may comprise the probabilistically inferred content generated by the AI engine 80 and stored in the generative buffer 274. For example, the narrative content may describe various details about how hockey player performance is measured, why the decision was made for the particular player, historical comparisons, etc. The probabilistically inferred content may comprise statistics gathered by the AI engine 80. However, the governance layer 100 may treat the statistics gathered by the AI engine 80 as inherently untrustworthy. The assembly module 184 may read the tokens in the output sequence from the generative buffer 274 (e.g., in the signal PR-FL). The assembly module 184 may identify locations at which the inferred content corresponds to the authoritatively bound roles stored in the fixed buffer 272 (e.g., in the signal ABR). The assembly module 184 may swap in the tokens from the authoritatively bound roles for the athlete statistics at the locations in the output sequence of the probabilistically inferred content. Swapping in the tokens of the authoritatively bound roles may replace the potentially untrustworthy values generated by the AI engine 80.

In some embodiments, the governance layer 100 may operate as an input-side only governance layer. For example, the governance layer 100 may provide the populated authoritatively bound roles to the AI engine 80, may not control how the AI engine 80 operates, and may not adjust the output of the AI engine 80. For the input-side only governance layer, the fixed buffer 272 may provide the populated authoritatively bound roles stored in the fixed buffer 272 to the token sequencer 102, which may be tokenized, overweighted and sent to the AI engine 80 as the signal AWT. The AI engine 80 may generate the structured output 154 in response to the signal AWT. For example, the tokens provided from the fixed buffer 272 may be given a high weight value by the token sequencer 102 to ensure that the AI engine 80 does not perform a replacement of the authoritatively bound roles when generating the probabilistically inferred content. When operating as the input-side only governance layer, the AI engine 80 may not benefit from providing the probabilistically inferred content to the generative buffer 274 for storage. Since the governance layer 100 may directly alter the output, then the governance layer 100 may not benefit from storing the probabilistically inferred content in the generative buffer 274.

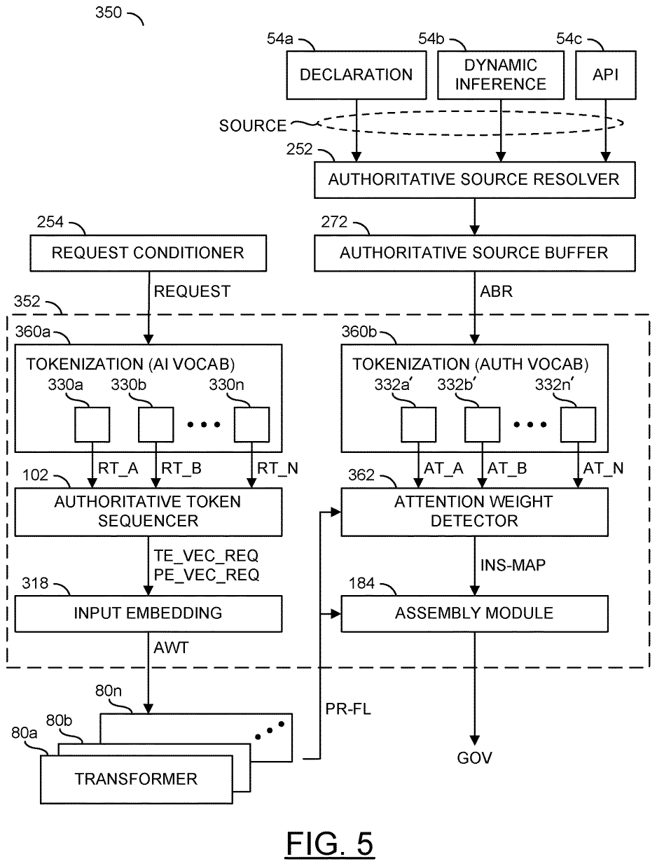

In some embodiments, the governance layer 100 may operate as an output-side only governance layer. For example, the AI engine 80 may generate the probabilistically inferred content and the governance layer 100 may add in the populated authoritatively bound roles using the assembly module 184. Since the governance layer 100 may combine the probabilistically inferred content from the AI engine 80 with the populated authoritatively bound role 200, the governance layer 100 may store the probabilistically inferred content generated by the AI engine 80 in the generative buffer 274. For example, the governance layer 100 may analyze the signal REQUEST to determine and then populate the authoritatively bound roles and store the tokens for the populated authoritatively bound roles in the fixed buffer 272. The governance layer 100 may forward the signal REQUEST to the AI engine 80 (e.g., as part of the signal AWT) after tokenization by the token sequencer 102 to enable the AI engine 80 to generate the probabilistically inferred content in response to the signal REQUEST. The signal PR-FL may be communicated to the governance layer 100 to enable the probabilistically inferred content to be stored in the generative buffer 274. Since the governance layer 100 may assemble the governed output, when operating as an output-side only governance layer, the governance layer 100 may not benefit from providing the signal ABR to the AI engine 80 as the signal AWT (e.g., to be described in association with FIG. 5). The assembly module 184 may combine the probabilistically inferred content from the generative buffer 274 with the populated authoritatively bound roles from the fixed buffer 272 to generate the structured output 154.

The structured output 154 may be provided to the downstream process 56. In some embodiments, the governance layer 100 may operate as an input side and output side governance layer. For example, on the input side, the token sequencer 102 may overweight the populated authoritatively bound role 200 as part of the signal AWT before the AI engine 80 generates the probabilistically inferred content, and the assembly module 184 may ensure accuracy by inserting the populated authoritatively bound role 200 into the structured output 154 by combining with the tokens of the signal PR-FL. Whether the governance layer 100 implements an input-side only governance layer, an output-side only governance layer or a combination input-side/output-side governance layer may be varied according to the design criteria of a particular implementation.

The governance layer 100 may enable the AI engine 80 to be permitted to infer values for the predefined semantic roles other than the authoritatively bound role. For example, the AI engine 80 may not change the authoritatively bound roles stored in the fixed buffer 272 but may provide the probabilistically inferred content for data other than the authoritatively bound roles. In one example, the AI engine 80 may generate narrative content that references the populated authoritatively bound role. The signal ABR may provide the content for the authoritatively bound role, and the governance layer 100 may prevent modification of the populated authoritatively bound role by the AI engine 80. However, the narrative content (e.g., the probabilistically inferred content) may be generated with respect to and/or by referring to the authoritatively bound roles. In an example, the AI engine 80 may perform probabilistic reasoning using the populated authoritatively bound role as a deterministic parameter.

The role identification module 180 may identify at least one of the predefined semantic roles as the authoritatively bound roles by analyzing the request from the end user (e.g., analyzing the signal REQUEST). The role identification module 180 may detect one or more factual assertions, numerical values, and/or verifiable data elements within a prospective response to the request, which may be susceptible to authoritative grounding from the authoritative data source 54. One of the validity conditions enforced by the constraint validation module 182 for the authoritatively bound roles may be a recency threshold. For example, the constraint validation module 182 may determine the recency threshold based on whether the authoritatively bound role corresponds to a static historical value or a dynamically changing current value.

In some embodiments, the authoritative data source 54 may be a closed system (e.g., only accessible from the client device 52 and/or with permission from the client device 52). For example, the data retrieval module 252 may be configured to maintain a designation record identifying the closed system as the authoritative data source 54 for one or more of the predefined semantic roles. The data retrieval module 252 may be configured to access the closed system via a designated application programming interface in response to the designation record. For example, the data retrieval module 252 may comprise a memory configured to store login credentials (or receive login credentials from the client device 52) for each designation record. The data retrieval module 252 may use the designated API to access the authoritative data source 54. The data retrieval module 252 may retrieve the value from the authoritative data source 54 via the API and the values may be stored in the fixed buffer 272. The data stored in the fixed buffer 272 may be deemed to be authoritative. The AI engine 80 may be prevented and/or discouraged via the overweighting from performing probabilistic substitution for the data stored in the fixed buffer 272.

In one example of a closed system for the authoritative data source 54, the closed system may be a medical record portal and the data source (e.g., the data provided in the signal SOURCE) may comprise a medical record. For example, for dosing a drug such as Vancomycin (e.g., a powerful intravenous antibiotic used to treat serious bacterial infections, particularly when other antibiotics have failed or when the bacteria are resistant), dosing may be high-stakes, safety critical and/or accuracy-critical (e.g., the therapeutic window may be narrow where too little may not work and too much may be nephrotoxic). Dosing may be weight-based and depend on current kidney function, which is measured by creatinine clearance. The patient weight, creatinine level, known allergies, current medications, etc. may be the authoritatively bound roles (e.g., every one has to come from the actual medical record). If the AI engine 80 guesses an average adult weight instead of retrieving the real value, the dose could be wrong in a way that kills the patient. The governance layer 100 may be configured to block execution of AI engine 80 when the data source cannot be retrieved from the closed system.

In some embodiments, the authoritative data source 54 may be supplied by the end user. For example, the signal SOURCE may comprise a pre-defined data segment supplied by the end user. In one example, the data segment may be a selection of text to be reproduced by the AI engine 80 word for word. For example, the data segment may be a citation. The data retrieval module 252 may receive the data segment, which may be stored in the fixed buffer 272.

In some embodiments, the authoritative data source 54 may be a third party. The signal SOURCE may comprise data retrieved from the third party. In one example, the third party may be identified by the end user in the signal REQUEST. In another example, the third party may be a government resource (e.g., a government website) and the acquired information may be regulations (e.g., construction codes, traffic regulations, zoning bylaws, etc.). In some embodiments, the data retrieval module 252 may perform an analysis of available resources in response to the authoritatively bound role identified by the role identification module 180. The data retrieval module 252 may select the third party in response to the analysis and retrieve the information from the authoritative data source 54. In one example, the data retrieval module 252 may store a ranking for trust levels for the available third party resources. In another example, the data retrieval module 252 may search other resources for a trust level of the third party resources. In yet another example, the data retrieval module 252 may generate a question for the end user comprising a list of the available resources. The data retrieval module 252 may then select the third party based on the selection from the list provided by the end user in response to the question.

The constraint validation module 182 may determine whether the candidate value (e.g., the signal CDVAL) satisfies the validity conditions before storing the populated authoritatively bound role in the fixed buffer 272. The validation constraints applied by the constraint validation module 182 may comprise one or more of a freshness threshold, a source trust level, a jurisdictional applicability check, a regulatory currency check, a signature verification, a provenance verification, a schema conformance check, a data type check, a value range check, a cross-source consistency check, etc. In one example, the validation constraints may be a data freshness threshold determined based on the authoritatively bound role. For example, when the authoritatively bound role is determined from a medical record and the data freshness threshold may comprise a time limitation for a patient medical attribute in response to a drug dosage (e.g., the patient attribute such as a patient weight must have been determined within the time limitations). In an example, the patient medical attributes may comprise one or more of a blood glucose level, a patient weight, a creatinine level, known allergies, current medications, etc. The particular validation constraints applied to the candidate value for the authoritatively bound role may be varied according to the design criteria of a particular implementation.

The AI engine 80 may generate explanatory and/or analytical content associated with the structured output 154 while the governance layer 100 maintains the populated authoritatively bound role 200 as fixed. In some embodiments, the populated authoritatively bound role 200 may constrain the reasoning performed by the AI engine 80 during generation of the remaining portions of the structured output 154. For example, since the fixed buffer 272 may not be modified by the AI engine 80, the populated authoritatively bound role 200 stored in the fixed buffer 272 may constrain the reasoning performed by the AI engine 80. The signal AWT may be provided to the AI engine 80 comprising a tokenized version of the conversational input of the signal REQUEST and a tokenized version of the populated authoritatively bound role 200. For example, the populated authoritatively bound role 200 may be inserted into a prompt, execution context, and/or structured template that may be provided to the AI engine 80.

Referring to FIG. 4, a block diagram illustrating an authoritative token sequencer is shown. A system 300 is shown. The system 300 may provide an example representation of a matched vocabulary tokenization system. The matched vocabulary tokenization system 300 may be enabled by the governance layer 100. The matched vocabulary tokenization system 300 may comprise multiple authoritative data sources 54a-54c, transformer models 80a-80n (e.g., implementations of the AI engines 80), the data retrieval module 252, the request conditioner 254, the fixed buffer 272 and/or a block (or circuit) 302. The circuit 302 may comprise a matched vocabulary tokenization architecture. The matched vocabulary tokenization system 300 may comprise other components (not shown). The number, type and/or arrangement of the components of the matched vocabulary tokenization system 300 may be varied according to the design criteria of a particular implementation.

Generally, the governance layer 100 may not affect the training of the AI engine 80 and/or the transformer models 80a-80n. For example, the governance layer 100 may enable the generation of governed output without re-training the AI model implemented by the transformer models 80a-80n. The multiple authoritative data sources 54a-54c may be a separate data source from a source that may update the transformer models 80a-80n. In some embodiments, the governance layer 100 may generate the signal GOV, as shown in association with FIGS. 2-3, to provide additional content for training data for the transformer models 80a-80n. However, any impact of the output of the governance layer 100 on the AI model implemented by the transformer models 80a-80n may not be usable until the next time the AI model is updated. For example, in a live operating environment, the output of the governance layer 100 may not affect how the transformer models 80a-80n work internally.

The multiple authoritative data sources 54a-54c may each be an example of the authoritative data source 54 described in association with FIGS. 1-3. In one example, the multiple authoritative data sources 54a-54c may comprise a database, a website, an article, a published scientific paper, an archive, a user declaration, an external system, a dynamically inferred source, etc. In the example shown, the authoritative data sources 54a may comprise a declaration (e.g., an input provided by the client device 52), the authoritative data sources 54b may comprise a dynamic inference, and the authoritative data sources 54c may comprise data received via an API. Each of the multiple authoritative data sources 54a-54c may provide authoritative input data to the governance layer 100. In the example shown, the multiple authoritative data sources 54a-54c may provide the signal SOURCE to the authoritative source resolver (e.g., data retrieval module 252).

In some embodiments, the data retrieval module 252 may be configured to resolve the multiple inputs received from the multiple authoritative data sources 54a-54c. For example, the multiple authoritative data sources 54a-54c may provide conflicting candidate values for the authoritatively bound role. In response to detecting conflicting candidate values, the constraint validation module 182 may select the candidate value from one of the multiple authoritative data sources 54a-54c with the highest trust level, apply a configured precedence rule, select the candidate value with the most recent timestamp, flag the conflict for end user resolution, treat the conflict as a validation failure, etc. The particular conflict resolution policy applied by the constraint validation module 182 may be varied according to the design criteria of a particular implementation.

In the example shown, the data retrieval module 252 may provide the signal ABR to the authoritative source buffer (e.g., fixed buffer 272). For example, for embodiments of the governance layer 100 that do not implement the constraint validation module 182 the data retrieval module 252 may provide the authoritatively bound roles received from the multiple authoritative data sources 54a-54c to the fixed buffer 272 (e.g., without checking for validation constraints). The fixed buffer 272 may forward the signal ABR to the matched vocabulary tokenization architecture 302.

The request conditioner 254 may be configured to condition the input (e.g., a request from an end user, a request from a system such as an autonomous driving stack, a request from the downstream process 56, etc.) for tokenization. The request conditioner 254 may be configured to forward the signal REQUEST to the matched vocabulary tokenization architecture 302. In some embodiments, the data retrieval module 252 may be configured to identify the input from the signal REQUEST as conversational input (e.g., natural language input). The operations performed by the request conditioner 254 may ensure the input is in a format that may be operated on by the matched vocabulary tokenization architecture 302.

The matched vocabulary tokenization architecture 302 may provide a portion of a transformer inference pipeline for the governance layer 100. The matched vocabulary tokenization architecture 302 may be configured to receive the input comprising the request (e.g., from an end user) via the signal REQUEST. The signal REQUEST may comprise the structured output template 152 comprising the semantic roles 162a-162n. The governance layer 100 may be configured to receive the authoritative data from the multiple authoritative data sources 54a-54c via the signal SOURCE and the data retrieval module 252 and/or the constraint validation module 182 may provide the populated authoritatively bound role 200 via the signal ABR. For example, the role identification module 180 may identify at least one of the semantic roles 162a-162n as an authoritatively bound role and the populated authoritatively bound role 200 may be generated in response to the signal SOURCE from the multiple authoritative data sources 54a-54c. The populated authoritatively bound role 200 may be stored in the fixed buffer 272.

The matched vocabulary tokenization architecture 302 may be configured to perform tokenization operations. The matched vocabulary tokenization architecture 302 may be configured to tokenize the populated authoritatively bound role 200 into an authoritative token sequence and tokenize the conversational input into a conversational token sequence. The matched vocabulary tokenization architecture 302 may be configured to perform overweighting and/or provide positional information for each of the token sequences. In the example shown, the matched vocabulary tokenization architecture 302 may generate a combined token sequence based on the authoritative token sequence and the conversational token sequence, which may comprise the overweighting and/or positional information. The combined token sequence may be output as the signal AWT. For example, the signal AWT may be presented to the transformer models 80a-80n.

The matched vocabulary tokenization architecture 302 may comprise the token sequencer 102, blocks (or circuits) 310a-310b, a block (or circuit) 312, a block (or circuit) 314, a block (or circuit) 316 and/or a block (or circuit) 318. The circuits 310a-310b may implement tokenization modules. The circuit 312 may implement a token embedding module. The circuit 314 may implement a positional encoding module. The circuit 316 may implement a token sequence combiner. The circuit 318 may implement an input embedding module. The matched vocabulary tokenization architecture 302 may comprise other components (not shown). The number, type and/or arrangement of the components of the matched vocabulary tokenization architecture 302 may be varied according to the design criteria of a particular implementation.

The two tokenization modules 310a-310b may be configured to operate on separate input paths. The tokenization modules 310a-310b may implement the same vocabulary. The vocabulary implemented by the tokenization modules 310a-310b may match the vocabulary of the transformer models 80a-80n. Matching the vocabularies of the tokenization modules 310a-310b to the transformer models 80a-80n may ensure that the token IDs generated by each input path may resolve correctly against a shared embedding matrix. For example, if the tokenization modules 310a-310b implemented different tokenizers with different vocabularies, the token IDs produced for each path may be drawn from different ID spaces and, when merged sequence the combined token sequence may comprise token IDs that may be mismatched, may resolve incorrectly and/or fail to resolve against a shared embedding matrix (e.g., the transformer models 80a-80n may receive corrupted input). The tokenization modules 310a-310b may provide vocabulary consistency for both input paths. Tokenizer version consistency may be maintained across both the tokenization modules 310a-310b. If the tokenizer is updated (e.g., vocabulary expansion, subword rule changes, other modifications, etc.), both of the tokenization modules 310a-310b may be updated together.

The tokenization module 310a may receive the conversational input from the signal REQUEST. The tokenization module 310a may comprise blocks 330a-330n. The blocks 330a-330n may be a conversational token sequence. The tokenization module 310a may be configured to convert the conversational input into the conversational token sequence 330a-330n. Each of the conversational token sequence 330a-330n may be provided to the token sequencer 102. The tokenization module 310a may be configured to generate signals (e.g., RT_A-RT_N). Each of the signals RT_A-RT_N may correspond to one of the tokens of the conversational token sequence 330a-330n. The signals RT_A-RT_N may be communicated to the token sequencer 102.

The tokenization module 310b may receive the populated authoritatively bound role 200 from the signal ABR. For example, the tokenization module 310b may retrieve the authoritatively bound role(s) held in the fixed buffer 272. The tokenization module 310b may comprise blocks 332a-332n. The blocks 332a-332n may be an authoritative token sequence. The authoritative token sequence 332a-332n may be a separate token sequence from the conversational token sequence 330a-330n. The tokenization module 310b may be configured to convert the authoritative input from the populated authoritatively bound role 200 into the authoritative token sequence 332a-332n. Each of the authoritative token sequence 332a-332n may be provided to the token sequencer 102. The tokenization module 310b may be configured to generate signals (e.g., AT_A-AT_N). Each of the signals AT_A-AT_N may correspond to one of the tokens of the authoritative token sequence 332a-332n. The signals AT_A-AT_N may be communicated to the token sequencer 102.

In some embodiment, the tokenization modules 310a-310b may operate on different inputs simultaneously. For example, the tokenization module 310a may receive the signal REQUEST and the tokenization module 310b may receive the signal ABR and the tokenization modules 310a-310b may respectively generate the conversational token sequence 330a-330n and the authoritative token sequence 332a-332n for the token sequencer 102 simultaneously (or substantially in parallel). In some embodiments, the tokenization modules 310a-310b may operate sequentially. For example, the tokenization module 310a may receive the conversational input from the request conditioner 254 first, while the role identification module 180, the data retrieval module 252 and the constraint validation module 182 identify the semantic roles 162a-162n, receive candidate values from the multiple authoritative data sources 54a-54c, validate the candidate values and store the populated authoritatively bound role 200 in the fixed buffer 272. After the tokenization module 310a generates the conversational token sequence 330a-330n, the tokenization module 310b may generate the authoritative token sequence 332a-332n. In some embodiments, one tokenization module may be implemented, and may operate on the conversational input and the authoritative input sequentially (e.g., the governance state of the governance layer 100 may control whether the single tokenization module generates the conversational token sequence 330a-330n or the authoritative token sequence 332a-332n). In some embodiments, when the tokenization modules 310a-310b operate sequentially, the first token sequence generated may be held separately pending delivery to the token sequencer 102 by the other of the tokenization modules 310a-310b. In some embodiments, the authoritatively bound content may be run through the tokenization module 310b to overweight the authoritative token sequence 332a-332n and the conversational input may be run through the tokenization module 310a. In some embodiments, one of the tokenization modules 310a-310b may be implemented, and the single tokenization module may operate in two modes (e.g., one mode of operation to provide the overweight while generating the authoritative token sequence 332a-332n and another mode of operation to generate the conversational token sequence 330a-330n without the overweight). The particular implementation of the tokenization modules 310a-310b may be varied according to the design criteria of a particular implementation.

The token sequencer 102 may receive the conversational token sequence 330a-330n via the signals RT_A-RT_N and the authoritative token sequence 332a-332n via the signals AT_A-AT_N. The combined length of the conversational token sequence 330a-330n and the authoritative token sequence 332a-332n may be selected to fit within the context window of the transformer models 80a-80n. The token sequencer 102 may be configured to arrange the conversational token sequence 330a-330n and the authoritative token sequence 332a-332n. Arranging the conversational token sequence 330a-330n and the authoritative token sequence 332a-332n may ensure that identified locations may be provided for analysis and/or insertion by the assembly module 184. In one example, the token sequencer 102 may be configured to arrange the conversational token sequence 330a-330n and the authoritative token sequence 332a-332n with the authoritative token sequence 332a-332n occupying positions one through N in a merged sequence (e.g., where N may be a length of the authoritative token sequence 332a-332n). The token sequencer 102 may arrange the conversational token sequence 330a-330n in remaining context window positions. In scenarios with the authoritative token sequence 332a-332n having a significant length, the available context window for conversational token sequence 330a-330n may be reduced (e.g., when the combination of the conversational token sequence 330a-330n and the authoritative token sequence 332a-332n exceeds the length of the context window, the positioning of the authoritative token sequence 332a-332n may take precedence over the conversational token sequence 330a-330n). In another example, the governance layer 100 (e.g., the constraint validation module 182) may be configured to summarize and/or truncate the populated authoritatively bound role 200 prior to tokenization to manage context window constraints. Summarizing and/or truncating the populated authoritatively bound role 200 may be implemented to ensure that the resulting authoritative token sequence 332a-332n may retain the content required to ground the output positions designated as insertion points downstream.

The conversational token sequence 330a-330n and the authoritative token sequence 332a-332n arranged by the token sequencer 102 may be provided for token embedding and positional encoding. In the example shown, the token embedding module 312 and the positional encoding module 314 may be distinct components from the token sequencer 102. In some embodiments, the token embedding module 312 and the positional encoding module 314 may be part of the token sequencing operations performed by the token sequencer 102. The particular arrangement of the token sequencer 102, the token embedding module 312 and the positional encoding module 314 may be varied according to the design criteria of a particular implementation.

The token sequencer 102 may be configured to merge two token sequences into a merged token sequence. For example, the authoritative token sequence 332a-332n may be merged with the conversational token sequence 330a-330n and the authoritative token sequence 332a-332n may be assigned positions preceding the conversational token sequence 330a-330n. In one example, the authoritative token sequence 332a-332n may be prepended completely. In another example, the token sequencer 102 may assign the authoritative token sequence 332a-332n to a reserved positional index range occupying the leading portion of the sequence, with conversational tokens allocated to subsequent indices. The sequencing operation may be performed prior to application of positional encoding. For example, the positional indices assigned during sequence construction may directly influence the encoding stage. The token sequencer 102 may further maintain positional integrity through padding, alignment constraints, and/or boundary markers to ensure that authoritative content occupies stable index ranges across varying input lengths. By assigning the authoritative token sequence 332a-332n to the leading positional indices, the governance layer 100 may introduce a structural bias into the attention mechanism of the transformer models 80a-80n (e.g., attention calculations may incorporate positional encodings, tokens appearing earlier in the sequence may exert greater or more stable influence during inference, particularly in early layers of the AI model). The positional seniority may increase a likelihood that authoritative content may be incorporated into attention pathways (e.g., reducing a risk that the authoritative content may be overshadowed by conversational tokens). For example, the precedence of the authoritative token sequence 332a-332n may be achieved through deterministic control of the input representation supplied to the transformer models 80a-80n instead of modification of model weights.

In some embodiments, the token sequencer 102 may dynamically adjust the extent of positional precedence based on characteristics of the authoritative source. For example, the characteristics of the multiple authoritative data sources 54a-54c may comprise confidence levels, source type, relevance scores, etc. The token sequencer 102 may allocate larger or smaller positional index ranges to different sources, which may enable hierarchical prioritization among multiple authoritative inputs. For example, the governance state stored in the evaluative object store 270 may indicate the amount of precedence to allocate for each of the multiple authoritative data sources 54a-54c. In an example, positional assignments may be made based on source type, such as legal authority, clinical data, user-provided constraints, and/or based on dynamic relevance assessments. The system may further maintain mappings between positional ranges and source identities, allowing downstream processes to interpret attention patterns in relation to specific sources. By allocating positional regions rather than merging content into a single undifferentiated sequence, the system preserves source-level structure and reduces interference between competing authoritative inputs. In some embodiments, interleaving may be performed by the token sequencer 102 to enable authoritative tokens to be distributed at defined intervals within the merged sequence while still maintaining overall precedence. Context window allocation strategies may be applied to ensure that authoritative content remains within high-attention regions of the effective context length of the transformer models 80a-80n. In some embodiments, the positional sequencing implemented by the token sequencer 102 may be used in combination with substitution, pointer-based retrieval, span identification, copy-channel mechanisms, alternate vocabulary processing, logic-gated assembly systems, etc. In such combined embodiments, the token sequencer 102 may operate upstream to guide model attention toward authoritative content, while downstream components may ensure that authoritative content may be inserted or preserved in exact form at designated output positions. For example, token sequencer 102 may enhance the effectiveness and reliability of downstream enforcement mechanisms.

The token sequencer 102 may generate flag tokens. A flag token may comprise a delimited placeholder having a recognizable format when expressed in character form. In one example, the delimited placeholder generated by the token sequencer 102 may comprise an opening delimiter, an identifier, and a closing delimiter (e.g., <<FLAG_01>>, {{WEIGHT}}, or [[DOSE_A]]). The token sequencer 102 may convert the character form of the delimited placeholder into one or more token identifiers (e.g., integer indices into the native vocabulary such as 27553, subword tokens such as FLAG and _01, byte-pair encoding tokens such as FL and AG and _01, WordPiece tokens such as FLAG and ##_01, SentencePiece tokens such as FLAG and _01, etc.) drawn from the native vocabulary of the transformers models 80a-80n. In another example, the converted form may comprise an opening delimiter token, one or more identifier tokens, and a closing delimiter token (e.g., the character form <<FLAG_01>> may be converted into an opening delimiter token corresponding to <<, one or more identifier tokens corresponding to FLAG_01, and a closing delimiter token corresponding to >>). The token sequencer 102 may operate on the converted form when producing the authoritative token sequence 332a-332n. The opening and closing delimiters may be selected to comprise character sequences that may tokenize into token identifiers unlikely to be produced by the transformers models 80a-80n during conversational output. The identifier between the delimiters may correspond to the entry of the fixed buffer 272 holding the populated authoritatively bound role 200 for substitution by the assembly module 184. The particular form of the delimiters, the identifier, the converted token identifiers, and the tokenization of the delimited placeholder into token identifiers may be varied according to the design criteria of a particular implementation.

The token embedding module 312 may be configured to generate token embedding information for the conversational token sequence 330a-330n and the authoritative token sequence 332a-332n. The token embedding module 312 may generate a signal (e.g., TE_VEC_REQ) and a signal (TE_VEC_ABR). The signal TE_VEC_REQ may comprise vector information that provides the token embeddings for the conversational token sequence 330a-330n. The signal TE_VEC_ABR may comprise vector information that provides the token embeddings for the authoritative token sequence 332a-332n. The token embedding module 312 may perform the token embedding to map token identifiers (e.g., token IDs) in the combined token sequence to a semantic vector using a shared embedding matrix. The signal TE_VEC_REQ and the signal TE_VEC_ABR may be communicated to the token sequence combiner 316.

The positional encoding module 314 may be configured to generate positional information for the conversational token sequence 330a-330n and the authoritative token sequence 332a-332n. The positional encoding module 314 may generate a signal (e.g., PE_VEC_REQ) and a signal (PE_VEC_ABR). The signal PE_VEC_REQ may comprise vector information that provides the positional information and/or the identified locations for the conversational token sequence 330a-330n. The signal PE_VEC_ABR may comprise vector information that provides the positional information and/or identified locations for the authoritative token sequence 332a-332n. The signal PE_VEC_REQ and the signal PE_VEC_ABR may be communicated to the token sequence combiner 316.

The token sequence combiner 316 may be configured to generate the combined token sequence. The combined token sequence may be generated by the token sequence combiner 316 from the conversational token sequence 330a-330n and the authoritative token sequence 332a-332n sequenced by the token sequencer 102. The token sequence combiner 316 may be configured to perform a vector summation operation on the positional and embedding information of the conversational token sequence 330a-330n and the authoritative token sequence 332a-332n. The token sequence combiner 316 may generate the combined token sequence in response to the signal TE_VEC_REQ, the signal PE_VEC_REQ, the signal TE_VEC_ABR and the signal PE_VEC_ABR. The combined token sequence may be presented to the input embedding module 318.

The input embedding module 318 may be configured to perform embedding operations on the combined token sequence. The input embedding operations may be configured to convert the raw tokens of the combined token sequence into fixed-size vectors that may be processed by the transformer models 80a-80n. The input embedding module 318 may map each token of the vectors in a continuous, high-dimensional space (e.g., an embedding matrix). The input embedding may capture semantic and/or syntactic relationships between the tokens of the combined token sequence to enable the transformer models 80a-80n to reason about similarity, analogy, context, etc. The input embedding module 318 may provide positional encodings to encode the order of the tokens in the combined token sequence. The input embedding module 318 may generate the signal AWT in response to the combined token sequence. The signal AWT may be an output of the matched vocabulary tokenization architecture 302.

The transformer models 80a-80n may receive the signal AWT. The signal AWT may be an input for the transformer models 80a-80n that may comprise the combined token sequence corresponding to the conversational input of the signal REQUEST and the overweighted authoritative input of the populated authoritatively bound role 200. The token sequencing performed by the token sequencer 102 may provide identified locations for the populated authoritatively bound role 200. The overweighting provided by the token sequencer 102 may overweight the populated authoritatively bound role 200 for the transformer models 80a-80n.

The transformer models 80a-80n may be configured to generate the signal PR-FL in response to the signal AWT. The transformer models 80a-80n may generate the probabilistically inferred output in response to at least the conversational token sequence. For example, in some scenarios, the governance layer 100 may determine that the output does not benefit from authoritatively bound content (e.g., the combined token sequence may be generated entirely from the conversational input without any authoritatively bound content). Generally, the matched vocabulary tokenization architecture 302 may generate the combined token sequence from both the conversational token sequence 330a-330n and the authoritative token sequence 332a-332n and the transformer models 80a-80n may generate the probabilistically inferred output from the combined token sequence. The overweighting performed by the token sequencer 102 may enable the probabilistically inferred content generated by the transformer models 80a-80n to be bound to the authoritatively bound role. However, the overweighting may not necessarily ensure that the transformer models 80a-80n may reliably repeat the populated authoritatively bound role 200 without probabilistic substitution. For example, even in scenarios where the transformer models 80a-80n does perfectly reproduce the populated authoritatively bound role 200, the governance layer 100 may not provide the structured output 154 without performing the assembly operations. The assembly operations may ensure that the governed output is bound to the populated authoritatively bound role 200.

The governance layer 100 may receive the probabilistically inferred content (e.g., the signal PR-FL) from the transformer models 80a-80n. The assembly module 184 may be configured to assemble the governed output that corresponds to the structured output 154 in response to inserting the populated authoritatively bound role 200 stored in the fixed buffer 272 into the identified locations of the probabilistically inferred output of the transformer models 80a-80n.

The token sequencer 102 may merge the authoritative token sequence 332a-332n with the conversational token sequence 330a-330n into the combined token sequence in response to assigning the authoritative token sequence 332a-332n with a reserved positional index. The reserved positional index may have a positional precedence over conversational token sequence 330a-330n. The probabilistically inferred output generated by the transformer models 80a-80n in response to the combined token sequence may comprise the reserved positional index. The identified locations of the probabilistically inferred output may correspond to the reserved positional index. For example, the merging of the conversational token sequence 330a-330n and the authoritative token sequence 332a-332n into the combined token sequence may be a positional operation configured to establish an order of authoritative token sequence 332a-332n with respect to conversational token sequence 330a-330n. The identified locations may be used by the assembly module 184 to insert the populated authoritatively bound role 200.

The token sequencer 102 may assign the authoritative token sequence 332a-332n to the reserved positional index prior to positional encoding by the positional encoding module 314 to structurally bias attention of the transformer models 80a-80n toward the populated authoritatively bound role 200 relative to the conversational input. The token sequencer 102 may allocate different ranges for the reserved positional index to multiple authoritative sources available (e.g., the multiple authoritative data sources 54a-54c) based on a prioritization hierarchy. For example, the token sequencer 102 may enforce a trust level for each of the multiple authoritative data sources 54a-54c using the reserved positional index. The merging performed by the token sequencer 102 of the conversational token sequence 330a-330n and the authoritative token sequence 332a-332n may comprise inserting one or more boundary markers separating the authoritative token sequence 332a-332n and the conversational token sequence 330a-330n.

By implementing the matched vocabulary tokenization architecture 302, the governance layer 100 may operate on a complementary two-mechanism principle. The token sequencer 102 may provide a probabilistic bias that may direct the transformer models 80a-80n toward the populated authoritatively bound role 200 during inference. The probabilistic bias may comprise overweighting, reserved positional indexing, vocabulary boundary enforcement, and/or other operations that may influence the probabilistically inferred output of the transformer models 80a-80n. The probabilistic bias may be effective for most inferences performed by the transformer models 80a-80n. However, the probabilistic bias may not guarantee verbatim reproduction of the populated authoritatively bound role 200 in the probabilistically inferred output. For example, in some scenarios, the transformer models 80a-80n may paraphrase, summarize, omit, and/or substitute the authoritative content despite the probabilistic bias.

The assembly module 184 may provide a deterministic substitution mechanism that may operate independently of the behavior of the transformer models 80a-80n at identified locations. The assembly module 184 may be configured to insert the populated authoritatively bound role 200 stored in the fixed buffer 272 into the identified locations of the probabilistically inferred output regardless of what content the transformer models 80a-80n generated at the identified locations. The probabilistic bias provided by the token sequencer 102 and the deterministic substitution provided by the assembly module 184 may be complementary. The probabilistic bias may be sufficient for most inferences but may not guarantee verbatim reproduction. The deterministic substitution may guarantee verbatim reproduction but may rely on the identified locations being recognizable in the probabilistically inferred output. Implementing both mechanisms together may ensure that no probabilistically inferred content reaches the governed output at positions designated as authoritatively bound.

Example pseudocode is shown representing the matched vocabulary tokenization system 300 (PC1):
PC1: //tokenization of the populated authoritatively bound role path
   FOR each semantic role 162 identified as an authoritatively bound role:
      retrieve populated authoritatively bound role 200 from fixed buffer 272
      FOR each measurement-carrying position P in the populated authoritatively bound role 200:
         emit flag token FT at position P from native vocabulary
         record in insertion point map:
         position index P
         fixed buffer entry reference
         flag type indicator
      output authoritative token sequence 332a
   // Merging and positional assignment
   token sequencer 102 assigns reserved positional index to authoritative token sequence 332a-332n
   token sequencer 102 inserts boundary markers between authoritative token sequence 332a-332n and conversational token sequence 330a-330n
   token sequencer 102 produces combined token sequence
   // Transformer inference
   signal AWT=combined token sequence
   transformers models 80a-80n receive AWT
   transformers models 80a-80n generate signal PR-FL
   // Assembly-side position recovery
   FOR each position P recorded in insertion point map:
      IF PR-FL contains flag token FT at position P:
         mark position P as confirmed
      ELSE:
      attention weight detector 362 reads attention pattern at position P
      IF attention pattern matches flag signature:
         mark position P as confirmed from attention
      ELSE:
         invoke missing-flag exception handling
   // Substitution
   FOR each confirmed position P in insertion point map:
      retrieve verbatim value V from fixed buffer 272 at recorded entry
      replace token at position P of PR-FL with V
      preserve boundary markers and adjust surrounding tokens for length assembly module 184 outputs structured output 154 as signal GOV

The assembly module 184 may operate as a failsafe for the probabilistic bias provided by the token sequencer 102. The assembly module 184 may be configured to perform substitution at each identified location regardless of the content generated by the transformer models 80a-80n at the identified location. The content generated by the transformer models 80a-80n at the identified location may comprise a flag token preserved from the authoritative token sequence 332a-332n, a paraphrase of the populated authoritatively bound role 200, an attempted reproduction of the populated authoritatively bound role 200, a native-vocabulary incompleteness signal, content unrelated to the populated authoritatively bound role 200, etc. In some embodiments, the assembly module 184 may discard the content generated by the transformer models 80a-80n at the identified location. The assembly module 184 may insert the populated authoritatively bound role 200 retrieved from the fixed buffer 272 verbatim at the identified location.

The substitution performed by the assembly module 184 may be unconditional with respect to the content generated by the transformer models 80a-80n at the identified location. For example, even when the transformer models 80a-80n may have correctly reproduced the populated authoritatively bound role 200 at the identified location, the assembly module 184 may still discard the reproduced content and insert the populated authoritatively bound role 200 retrieved from the fixed buffer 272 verbatim. Performing the substitution unconditionally may ensure that the governed output may be bound to the fixed buffer 272 by the architecture of the governance layer 100 rather than by the transformer models 80a-80n. The behavior of the transformer models 80a-80n at the identified locations may be irrelevant to the populated authoritatively bound role 200 in the governed output. The probabilistic bias provided by the token sequencer 102 may operate as guidance for the transformer models 80a-80n to generate surrounding content that may be coherent with the populated authoritatively bound role 200, rather than as a mechanism upon which the governance layer 100 may rely for verbatim reproduction.

In the matched vocabulary tokenization architecture 302, the token sequencer 102 may determine a structural effect on inference. The token sequencer 102 may operate upstream of the input embedding module 318. The token sequencer 102 may receive the conversational token sequence 330a-330n and the authoritative token sequence 332a-332n from the tokenization modules 310a-310b and then produce a merged ordered sequence. The merged sequence is then passed to an embedding stage (e.g., a transformer pipeline) of the matched vocabulary tokenization architecture 302 (e.g., the token embedding module 312, the positional encoding module 314, the token sequence combiner 316 and the input embedding module 318, where each token identifier is mapped to an embedding vector through the shared embedding matrix). The token sequencer 102 may operate on the tokens before the tokens are converted to embeddings. The token sequencer 102 may determine which tokens, in which order, may be presented to the embedding stage. The subsequent inference operations performed by the transformer models 80a-80n (e.g., self-attention computation, feed-forward processing, output projection, etc.) all operate on the embedded representation produced by the embedding stage. The upstream positioning implemented by the token sequencer 102 may control what is accessible by the inference operations of the transformer models 80a-80n.

The positional ordering implemented by the token sequencer 102 may propagate through the embedding stage into attention computation by the transformer models 80a-80n. The self-attention mechanism of the transformer models 80a-80n may operate on embedded token representations, with attention weights computed from query-key dot products over the embeddings. The positional encoding may be added to token embeddings before self-attention, and tokens occupying earlier positions in the merged sequence may receive positional encodings that propagate through the attention computation. Since the token sequencer 102 may prepend the authoritative token sequence 332a-332n to positions one through N of the merged sequence, the authoritative tokens may carry positional encodings that may bias attention weighting toward the authoritative token sequence 332a-332n in the combined sequence. The positional bias may provide a structural feature for the embedded representation (e.g., rather than a behavioral instruction to the AI model). For example, since the weighting follows from the embedded representation provided by the token sequencer 102 (and the embedding stage), the transformer models 80a-80n may not need to be trained, instructed, or otherwise induced to weight the authoritative token sequence 332a-332n more heavily.

The token sequencer 102 may not directly modify embedding vectors. The token sequencer 102 may modify the token sequence presented to the embedding stage. The embedding stage (e.g., operations performed by the token embedding module 312, the positional encoding module 314, the token sequence combiner 316 and/or the input embedding module 318) may then produce an embedded representation in which the structural prioritization provided by the token sequencer 102 may be realized through the combination of token order, positional encoding, and/or the shared embedding matrix. The operations performed by the transformer models 80a-80n may read the embedded representation of the signal AWT and produce the output that may correspond to the structural prioritization established by the token sequencer 102. For example, the transformer models 80a-80n may be unable to disregard the authoritative content because the authoritative content may be present with structural priority that may be encoded in the embedded representation used as input for the operations of the transformer models 80a-80n.

The token sequencer 102 may be distinguished from a retrieval-augmented generation (RAG) or other implementations that operate at architecturally distinct points in the inference pipeline. The token sequencer 102 may have a distinct architectural locus from a RAG. The architectural local of the token sequencer 102 may structurally guarantee that the embedding-stage prioritization may not be available through approaches that operate at other points in the inference pipeline. For example, RAG may operate upstream from tokenization and not at the embedding stage and the retrieved content may be concatenated with or interleaved into the input text string before the input is tokenized. The retrieved content may be tokenized by the same tokenizer as the rest of the input and may produce embedding vectors indistinguishable from any other input embeddings (e.g., RAG may have no mechanism to differentiate retrieved content from user input at the embedding stage and no mechanism to prioritize retrieved content over the user input in the embedded representation). Because RAG may produce an embedded representation in which retrieved content has no structural distinction from user input, the output of the transformer models 80a-80n may not be bounded by the retrieved content (e.g., the transformer models 80a-80n may attend to the retrieved content, ignore, paraphrase, and/or contradict the retrieved content depending on the inference behavior over the homogeneous embedded sequence). Similarly, output filtering may be structurally distinct from the token sequencer 102 by operating on the output token sequence generated by the transformer models 80a-80n (e.g., output filtering may accept or reject the output after output generation) and input-based steering may be structurally distinct from the token sequencer 102 by operating within the input text string (e.g., instruction text may be tokenized and embedded along with the rest of the input and produces an embedded representation in which the instructions has no structural priority over the content). By contrast, the token sequencer 102 may differentiate the authoritative content from the conversational input at the embedding stage. For example, the positional encoding may be applied at the embedding stage and may propagate into the attention computation by the transformer models 80a-80n. The positioning of the token sequencer 102 at the boundary between tokenization and the embedding stage may enable the governance layer 100 to control what the embedding stage receives, and establish structural prioritization in the embedded representation that the inference operations of the transformer models 80a-80n cannot disregard.

Referring to FIG. 5, a block diagram illustrating an alternate embodiment of an authoritative token sequencer architecture is shown. A system 350 is shown. The system 350 may provide an example representation of an authoritative bypass tokenization system. The authoritative bypass tokenization system 350 may be enabled by the governance layer 100. The authoritative bypass tokenization system 350 may have a similar implementation as the matched vocabulary tokenization system 300 shown in association with FIG. 4. The authoritative bypass tokenization system 350 may comprise the multiple authoritative data sources 54a-54c, transformer models 80a-80n, the data retrieval module 252, the request conditioner 254, the fixed buffer 272 and/or a block (or circuit) 352. The circuit 352 may comprise an authoritative bypass tokenization architecture. The authoritative bypass tokenization system 350 may comprise other components (not shown). The number, type and/or arrangement of the components of the authoritative bypass tokenization system 350 may be varied according to the design criteria of a particular implementation.

The authoritative bypass tokenization architecture 352 may provide a portion of a transformer inference pipeline for the governance layer 100. The authoritative bypass tokenization architecture 352 may be configured to receive the input comprising the request (e.g., from an end user) via the signal REQUEST and the authoritative data from the multiple authoritative data sources 54a-54c via the signal SOURCE similar to the matched vocabulary tokenization architecture 302 described in association with FIG. 4. For example, the role identification module 180 may identify at least one of the semantic roles 162a-162n as an authoritatively bound role and the populated authoritatively bound role 200 may be generated in response to the signal SOURCE from the multiple authoritative data sources 54a-54c. The populated authoritatively bound role 200 may be stored in the fixed buffer 272.

The authoritative bypass tokenization architecture 352 may be configured to perform tokenization operations. The authoritative bypass tokenization architecture 352 may be configured to tokenize the populated authoritatively bound role 200 into an authoritative token sequence and tokenize the conversational input into a conversational token sequence. The authoritative bypass tokenization architecture 352 may be configured to provide positional information for the authoritative token sequences. In the example shown, the authoritative bypass tokenization architecture 352 may generate an insertion map for the authoritative token sequence, while the conversational token sequence may comprise positional information. The conversational token sequence may be output as the signal AWT. For example, the signal AWT may be presented to the transformer models 80a-80n.

The authoritative bypass tokenization architecture 352 may comprise the token sequencer 102, the assembly module 184, the input embedding module 318, blocks (or circuits) 360a-360b, and/or a block (or circuit) 362. The circuits 360a-360b may implement tokenization modules. The circuit 362 may implement an attention weight detector. While the assembly module 184 is shown as part of the authoritative bypass tokenization architecture 352 for illustrative purposes, the assembly module 184 may not necessarily be implemented as part of the authoritative bypass tokenization architecture 352 (e.g., the assembly module 184 may operate independently from the authoritative bypass tokenization architecture 352). The authoritative bypass tokenization architecture 352 may comprise other components (not shown). The number, type and/or arrangement of the components of the authoritative bypass tokenization architecture 352 may be varied according to the design criteria of a particular implementation.

The two tokenization modules 360a-360b may be configured to operate on separate input paths. The tokenization module 360a may operate on the conversational input path and the tokenization module 360b may operate on the authoritative input path. The tokenization modules 360a-360b may each implement a different vocabulary. In the example shown, the tokenization module 360a may use an AI model vocabulary and the tokenization module 360b may use an authoritative vocabulary.

The AI model vocabulary tokenization module 360a may receive the conversational input from the signal REQUEST. The AI model vocabulary tokenization module 360a may comprise the conversational token sequence 330a-330n. The AI model vocabulary tokenization module 360a may be configured to convert the conversational input into the conversational token sequence 330a-330n. The signals RT_A-RT_N comprising the conversational token sequence 330a-330n may be communicated to the token sequencer 102.

The vocabulary implemented by the AI model vocabulary tokenization module 360a may match the vocabulary of the transformer models 80a-80n. Matching the vocabularies of the AI model vocabulary tokenization module 360a to the transformer models 80a-80n may ensure that the token IDs generated by the conversational input path may resolve correctly against a shared embedding matrix. Matching the vocabulary of the AI model vocabulary tokenization module 360a to the vocabulary of the AI engine 80 may ensure compatibility (e.g., that the shared matrix may be matched, may resolve correctly and/or prevent the transformer models 80a-80n from receiving corrupted input).

The authoritative vocabulary tokenization module 360b may receive the populated authoritatively bound role 200 from the signal ABR. For example, the authoritative vocabulary tokenization module 360b may retrieve the authoritatively bound role(s) held in the fixed buffer 272. The authoritative vocabulary tokenization module 360b may comprise blocks 332a′-332n′. The blocks 332a′-332n′ may be an alternate vocabulary authoritative token sequence. The alternate vocabulary authoritative token sequence 332a′-332n′ may be a separate token sequence from the conversational token sequence 330a-330n. The alternate vocabulary authoritative token sequence 332a′-332n′ may be generated using a different vocabulary and/or may be incompatible with the conversational token sequence 330a-330n. The authoritative vocabulary tokenization module 360b may be configured to convert the authoritative input from the populated authoritatively bound role 200 into the alternate vocabulary authoritative token sequence 332a′-332n′. Each of the alternate vocabulary authoritative token sequence 332a′-332n′ may be provided to the attention weight detector 362. The authoritative vocabulary tokenization module 360b may be configured to generate the signals AT_A-AT_N. Each of the signals AT_A-AT_N may correspond to one of the tokens of the alternate vocabulary authoritative token sequence 332a′-332n′.

For the authoritative bypass tokenization architecture 352, rather than requiring both the AI model vocabulary tokenization module 360a and the authoritative vocabulary tokenization module 360b to implement the same tokenizer, the authoritative bypass tokenization architecture 352 may assign a separate domain-specific vocabulary to the authoritative vocabulary tokenization module 360b. The alternate vocabulary authoritative token sequence 332a′-332n′ may be tokenized using the alternate vocabulary and held in the fixed buffer 272 with the alternate vocabulary format. Since the alternate vocabulary authoritative token sequence 332a′-332n′ may be generated by the alternate vocabulary that does not match the vocabulary of the transformer models 80a-80n, the alternate vocabulary authoritative token sequence 332a′-332n′ may not be compatible with and/or introduced into the input sequence for the transformer models 80a-80n. Due to the mismatched vocabulary, the transformer models 80a-80n may be architecturally incapable of generating the authoritative content (e.g., the content may not exist in the vocabulary of the transformer models 80a-80n). For example, when the structured output 154 requires authoritative content, the transformer models 80a-80n may not produce the authoritative content directly (e.g., not based on the populated authoritatively bound role 200, but may be capable of independently determining the same result).

For the conversational input path, the AI model vocabulary tokenization module 360a may provide the signals RT_A-RT_N to the token sequencer 102. The token sequencer 102 may be configured to perform the sequencing operations for only the conversational token sequence 330a-330n. Components of the embedding stage (e.g., the token embedding module 312 and the positional encoding module 314, described in association with FIG. 4) may be present in the authoritative bypass tokenization architecture 352 but are not shown in FIG. 5 for clarity. The token sequencer 102 may generate the signal TE_VEC_REQ and the signal PE_VEC_REQ. Since the token sequencer 102 may not receive, interact with and/or operate on the alternate vocabulary authoritative token sequence 332a′-332n′, for the authoritative bypass tokenization architecture 352, the token sequencer 102 may not generate token embedding vectors and/or positional encoding vectors for the authoritative token sequence. For example, for the authoritative bypass tokenization architecture 352, the token sequencer 102 may add and/or select a type of placeholder marker that may be used by the transformer models 80a-80n. The token sequencer 102 may present the signal TE_VEC_REQ and the signal PE_VEC_REQ to the input embedding module 318. Since the token sequencer 102 may operate on only the conversational token sequence 330a-330n, the authoritative bypass tokenization architecture 352 may not benefit from the combination operations performed by the token sequence combiner 316.

The input embedding module 318 may generate the signal AWT in response to the signal TE_VEC_REQ and the signal PE_VEC_REQ. The signal AWT may comprise positional information for the conversational token sequence 330a-330n. Since the signal AWT for the authoritative bypass tokenization architecture 352 may not comprise authoritative tokens, the signal AWT may not be overweighted for authoritative content.

The transformer models 80a-80n may receive the signal AWT. The AI engine 80 may receive only the conversational token sequence in the signal AWT. The conversational token sequence 330a-330n may be tokenized in the native vocabulary of the AI engine 80. The AI engine 80 may operate entirely within the native vocabulary space during inference. The AI engine 80 may provide the signal PR-FL to the governance layer 100. The signal PR-FL may be received by the attention weight detector 362 and/or the assembly module 184. For simplicity, the generative buffer 274 storing the probabilistically inferred output of the transformer models 80a-80n described in association with FIG. 3 has been omitted.

The signal PR-FL may comprise placeholder markers. The placeholder markers may be used as identified positions for the assembly module 184 to insert the populated authoritatively bound role 200. The transformer models 80a-80n may generate native vocabulary that may indicate and/or signal incompleteness at the positions corresponding to authoritatively bound roles. The placeholder markers may comprise a reserved gap marker token, a low-confidence token sequence, an explicit placeholder in the native vocabulary, etc. The particular type of placeholder markers used as the identified positions may be varied according to the design criteria of a particular implementation.

In one example, the incompleteness may be indicated by a reserved gap marker token defined for a placeholder marker. The reserved gap marker token may comprise a token of the native vocabulary that may be defined in advance as a placeholder marker. The attention weight detector 362 may identify the placeholder marker by recognizing the token identifier of the reserved gap marker token in the signal PR-FL. The reserved gap marker token may be a token already present in the native vocabulary of pre-trained transformer models 80a-80n (e.g., a structured-output token, a JSON null token, an XML self-closing tag token, etc.) and/or a token added to the native vocabulary specifically for the placeholder marker.

In another example, the incompleteness may be indicated by a low-confidence token sequence. The transformer models 80a-80n may generate the probabilistically inferred output as a sequence of tokens, where each token may be associated with one or more confidence values (e.g., a logit probability, an entropy measurement, a softmax probability, a top-k distribution width, etc.). The attention weight detector 362 may receive the confidence values from the transformer models 80a-80n. The attention weight detector 362 may compare the confidence values to a confidence threshold. The attention weight detector 362 may identify a position of the probabilistically inferred output as a placeholder marker in response to the confidence values for the position falling below the confidence threshold. In some embodiments, the attention weight detector 362 may identify the placeholder marker in response to a sequence of consecutive positions where the confidence values fall below the confidence threshold (e.g., a low-confidence token sequence). The confidence threshold may be a fixed value, a configurable value, and/or a value determined dynamically in response to the distribution of confidence values across the probabilistically inferred output. The low-confidence token sequence may indicate that the transformer models 80a-80n may have been unable to generate grounded content at the position and/or that the position corresponds to an authoritatively bound role for which the authoritative content was not available to the transformer models 80a-80n.

In yet another example, the incompleteness may be indicated by an explicit placeholder in the native vocabulary. The explicit placeholder may comprise one or more native-vocabulary tokens that may correspond to a structured-output convention recognized by the attention weight detector 362. For example, the explicit placeholder may comprise bracket pairs (e.g., <>, [], {}), structured field markers (e.g., field-name colons followed by empty values), JSON null tokens, XML empty-element tokens, code-comment placeholders (e.g., TODO, FIXME), and/or other patterns that may exist in the native vocabulary of pre-trained transformer models 80a-80n. The transformer models 80a-80n may generate the explicit placeholder when generating output corresponding to a position requiring authoritative content that may not be available within the conversational input and/or the native vocabulary. The attention weight detector 362 may recognize the explicit placeholder in the signal PR-FL by pattern matching against a configured set of explicit placeholder patterns.

The attention weight detector 362 may receive the signals AT_A-AT_N from the authoritative vocabulary tokenization module 360b (e.g., the signals AT_A-AT_N generated by the authoritative vocabulary tokenization module 360b may be stored in the fixed buffer 272). The attention weight detector 362 may receive the signal PR-FL from the transformer models 80a-80n. The attention weight detector 362 may be configured to reads an attention pattern at the positions corresponding to the placeholder markers in the signal PR-FL to identify the insertion points for the alternate vocabulary authoritative token sequence 332a′-332n′. For example, the attention weight detector 362 may recognizing probabilistically inferred output of the transformer models 80a-80n at the positions of the placeholder markers may not be grounded in authoritative content and marked for substitution. The attention weight detector 362 may generate an insertion point map in response to the placeholder markers and/or the alternate vocabulary authoritative token sequence 332a′-332n′. The insertion point map may indicate where to insert the alternate vocabulary authoritative token sequence 332a′-332n′ into the probabilistically inferred content generated by the transformer models 80a-80n. The attention weight detector 362 may generate a signal (e.g., INS-MAP). The signal INS-MAP may comprise the insertion point map. The signal INS-MAP may be presented to the assembly module 184. In some embodiments, the signal INS-MAP may forward the alternate vocabulary authoritative token sequence 332a′-332n′ generated by the authoritative vocabulary tokenization module 360b and/or the probabilistically inferred content generated by the transformer models 80a-80n.

The assembly module 184 may receive the signal INS-MAP. In some embodiments, the assembly module 184 may receive the signals AT_A-AT_N and/or the signal PR-FL. The assembly module 184 may be configured to operate on the insertion point map. The assembly module 184 may retrieve the corresponding populated authoritatively bound role 200 (e.g., the verbatim authoritative tokens stored in the fixed buffer 272). The assembly module 184 may be configured to substitute the alternate vocabulary authoritative token sequence 332a′-332n′ into the output sequence (e.g., the probabilistically inferred content with placeholder markers) at the designated positions indicated by the insertion point map. The tokens generated by the transformer models 80a-80n that occupied the insertion point map positions may be discarded. The assembly module 184 may generate the signal GOV. The final governed output sequence may contain the transformer-generated content in the native vocabulary of the transformer AI model at the unflagged positions, and the authoritative token sequence 332a-332n (e.g., verbatim authoritative content) in the alternate vocabulary at the insertion points. In some embodiments, the assembly module 184 may comprise an output rendering layer that may be configured to resolve both vocabulary spaces into the final text delivered to the downstream process 56.

Example pseudocode is shown representing the authoritative bypass tokenization system 350 (PC2):
PC2: //tokenization using alternate vocabulary
   FOR each semantic role 162 identified as an authoritatively bound role:
      retrieve populated authoritatively bound role 200 from fixed buffer 272
      tokenize role 200 using alternate vocabulary
      output alternate vocabulary authoritative token sequence 332a′-332n′
   FOR each position P occupied by alternate vocabulary authoritative token sequence 332a′-332n′:
      record in insertion point map:
      position index P
      fixed buffer entry reference
      alternate vocabulary token identifier
   //Presentation to transformer
   SELECT presentation approach:
      approach 1: substitute native-vocabulary sentinel token at each position P
      approach 2: map alternate-vocabulary token to reserved embedding slot
      approach 3: provide position P to positional encoding module 314 only withhold content from input embedding module 318
   token sequencer 102 produces combined token sequence with selected presentation
   // Transformer inference
   signal AWT=combined token sequence
   transformers models 80a-80n receive AWT
   transformers models 80a-80n generate signal PR-FL
      //transformer emits native-vocabulary filler tokens at positions P
      // because alternate-vocabulary content is not in native vocabulary
   //Assembly
   FOR each position P recorded in insertion point map:
      discard native-vocabulary filler token emitted by transformer at P
      retrieve verbatim value V from fixed buffer 272 at recorded entry
      place V at position P in output sequence
      preserve boundary markers and adjust surrounding tokens for length
   //Output rendering
   FOR each position in output sequence:
      IF position is unflagged:
         detokenize using native vocabulary of transformers models 80a-80n
      ELSE:
      detokenize using alternate vocabulary
   concatenate detokenized portions in positional order
   assembly module 184 outputs structured output 154 as signal GOV

In the matched vocabulary tokenization architecture 302, described in association with FIG. 4, the token sequencer 102 may assign positional precedence to authoritative tokens (e.g., the authoritative token sequence 332a-332n), causing the attention mechanism of the transformer models 80a-80n to weight the authoritative token sequence 332a-332n more heavily than the conversational token sequence 330a-330n. The matched vocabulary tokenization architecture 302 may provide probabilistic bias that may be strong and structurally grounded, and operating within the generative capacity of the transformer models 80a-80n. The transformer models 80a-80n may attend heavily to the authoritative token sequence 332a-332n and the probabilistically inferred content may adhere to the weighting, but the transformer models 80a-80n may still paraphrase, summarizing, and/or otherwise transform the authoritative content through the generative process. The assembly module 184 may ensure that the content that may still be potentially inaccurate may be bound to the authoritative token sequence 332a-332n. For example, if there is an error in the assembly module 184, the probabilistically inferred content may not be correctly substituted. The governance state tracked by the governance layer 100 may prevent output that is not authoritatively bound from being output. By contrast, with the authoritative bypass tokenization architecture 352, no potential generative path for the authoritatively bound content may exist. Since the alternate vocabulary authoritative token sequence 332a′-332n′ may be generated with the alternate vocabulary and may be incompatible with the transformer models 80a-80n, the transformer models 80a-80n cannot reach and/or modify the authoritative content at all (e.g., the vocabulary boundary may be a hard structural prohibition rather than an attentional bias). Preventing any potentially probabilistically inferred content from being output as authoritative using the authoritative bypass tokenization architecture 352 may be beneficial for scenarios where exact verbatim reproduction of authoritative content is required and paraphrase is unacceptable (e.g., patent claim language, statutory text, medical record entries, financial instrument terms, etc.).

The alternate vocabulary implemented by the authoritative vocabulary tokenization module 360b and the native vocabulary of the transformer models 80a-80n implemented by the AI model vocabulary tokenization module 360a may be maintained as distinct vocabulary spaces with disjoint token identifier ranges. In one example, token identifiers of the alternate vocabulary may be assigned to a numerical range that does not overlap with the numerical range of token identifiers of the native vocabulary. In another example, token identifiers of the alternate vocabulary may be tagged with a vocabulary identifier, a namespace prefix, and/or a sentinel bit that distinguishes the token identifiers of the alternate vocabulary from the token identifiers of the native vocabulary. In yet another example, the assembly module 184 may maintain a vocabulary registry that associates each token identifier in the output sequence with the source vocabulary that produced the token identifier. The vocabulary membership of any token in the output sequence may be unambiguously determined by the assembly module 184, which may enable the assembly module 184 to identify authoritative content in the output sequence as content drawn from the alternate vocabulary and to identify probabilistically inferred content in the output sequence as content drawn from the native vocabulary. The particular method of distinguishing the token identifiers of the alternate vocabulary from the token identifiers of the native vocabulary may be varied according to the design criteria of a particular implementation.

The alternative vocabulary implemented by the authoritative vocabulary tokenization module 360b may not necessarily be a complete language model vocabulary. In one example, the authoritative vocabulary may be a verbatim character-level or subword-level encoding of the authoritative source content only, which may be sufficient to represent the populated authoritatively bound role 200 content exactly for substitution. The complexity of the authoritative vocabulary may scale with the particular domain. In one example, for a legal document, the vocabulary may require coverage of specialized terminology and/or citation formats. In another example, for a medical record, the vocabulary may require coverage of clinical codes, dosage notations, structured data fields, etc. Generally, a defining characteristic of the authoritative vocabulary may be that the authoritative vocabulary may be designed for exact reproduction rather than generative flexibility. The particular vocabulary implemented by the authoritative vocabulary tokenization module 360b may be varied according to the design criteria of a particular implementation.

The assembly module 184 may identify locations of the probabilistically inferred output for substitution of the populated authoritatively bound role 200 using one or more identified-location mechanisms. In some embodiments, the assembly module 184 may implement a single identified-location mechanism. In some embodiments, the assembly module 184 may implement multiple identified-location mechanisms in a hierarchy where one identified-location mechanism may serve as a fallback for another identified-location mechanism. The particular identified-location mechanism and/or combination of identified-location mechanisms may be varied according to the design criteria of a particular implementation.

In some embodiments, an identified-location mechanism may comprise flag-token recognition. The token sequencer 102 may emit a flag token in a native vocabulary of the transformer models 80a-80n at a position corresponding to a populated authoritatively bound role 200. The flag token may be communicated to the transformer models 80a-80n as part of the authoritative token sequence 332a-332n. The transformer models 80a-80n may preserve the flag token in the probabilistically inferred output at the same position. The assembly module 184 may identify the position by direct token match against the flag token in the signal PR-FL.

In some embodiments, an identified-location mechanism may comprise attention-pattern recovery. The transformer models 80a-80n may, in some scenarios, fail to preserve the flag token at the position. For example, the transformer models 80a-80n may paraphrase, summarize, and/or substitute the flag token during the probabilistic reasoning. The attention weight detector 362 may be configured to read an attention pattern at the position recorded in the insertion point map. The assembly module 184 may identify the position as a confirmed insertion point in response to the attention pattern indicating that the transformer models 80a-80n attended to the authoritative token sequence 332a-332n while generating the output at the position. The attention-pattern recovery may operate as a fallback to the flag-token recognition. The attention-pattern recovery may also operate as a primary identified-location mechanism in embodiments where the authoritative token sequence is not provided to the transformer models 80a-80n.

In some embodiments, an identified-location mechanism may comprise native-vocabulary incompleteness signaling. The transformer models 80a-80n may generate, in the native vocabulary, content that may indicate and/or signal that the probabilistic reasoning was unable to produce grounded content at the position. The native-vocabulary incompleteness signal may be generated when the authoritative content may not be available in the vocabulary of the transformer models 80a-80n, when the conversational input does not provide sufficient context for the transformer models 80a-80n to generate the content at the position, when authoritative content is prevented from reaching the transformer models 80a-80n (e.g., to be described in association with FIG. 5). For example, the native-vocabulary incompleteness signal may comprise one or more of a reserved gap marker token, a low-confidence token sequence, and an explicit placeholder, etc.

The identified-location mechanisms may be implemented separately or in combination. In some embodiments, the assembly module 184 may apply the flag-token recognition first, the attention-pattern recovery as a fallback when no flag token is found at the recorded position, and the native-vocabulary incompleteness signaling as a further fallback when the attention pattern does not satisfy a confidence threshold. In some embodiments, the authoritative bypass tokenization architecture 352 may rely primarily on the native-vocabulary incompleteness signaling and the attention-pattern recovery, with the flag-token recognition unavailable due to the authoritative content not entering the transformer models 80a-80n.

The authoritative bypass tokenization architecture 352 may enable the transformer models 80a-80n to generate surrounding content in the native vocabulary (e.g., the probabilistically inferred content) and, at one or more positions, an indication that authoritative content may be inserted. The indication may provide a placeholder marker that may show that the transformer models 80a-80n has reached a position requiring content not representable in the native vocabulary. The assembly module 184 may receive the transformer output (e.g., the signal PR-FL) together with the insertion point map (e.g., the signal INS-MAP) identifying positions at which the populated authoritatively bound role 200 may be substituted. For each identified position (or span of positions), the assembly module 184 may retrieve a corresponding token sequence from the fixed buffer 272. Because the alternate vocabulary authoritative token sequence 332a′-332n′ was produced from the signal SOURCE using the alternate vocabulary implemented by the authoritative vocabulary tokenization module 360b, the retrieved token sequence preserves the exact wording, order, and content of the authoritative source. The assembly module 184 may then substitute the retrieved alternate vocabulary authoritative token sequence 332a′-332n′ for the transformer-generated placeholder span. The authoritative bypass tokenization architecture 352 may provide a hard separation between generative content and authoritative content.

In some embodiments, the alternate vocabulary implemented by the authoritative vocabulary tokenization module 360b may be a character-level, subword-level, or domain-specific encoding sufficient to represent the authoritative source exactly. The assembly module 184 may maintain the authoritative token sequence in that alternate vocabulary until a final rendering stage, at which point the alternate vocabulary authoritative token sequence 332a′-332n′ may be decoded into the exact text of the authoritative source and combined with the transformer-generated surrounding text for delivery as the governed output in the structured output 154. In some embodiments, substitution may be performed for a single token position. In some embodiments, substitution may be performed for a contiguous span corresponding to a phrase, sentence, clause, field value, claim term, record entry, etc. requiring exact reproduction.

In the authoritative bypass tokenization architecture 352, the token sequencer 102 may provide structural prioritization differently than for the matched vocabulary tokenization architecture 302. Rather than positional ordering within a shared embedding space, the authoritative bypass tokenization architecture 352 may implement vocabulary separation to prevent authoritative content from being represented in the embedding matrix of the transformer models 80a-80n. The authoritative token sequence may be held in a separate vocabulary implemented by the authoritative vocabulary tokenization module 360b that may have no entries in the shared embedding matrix. When the embedding stage (e.g., the token embedding module 312, the positional encoding module 314 and/or the input embedding module 318) attempts to map tokens to embedding vectors, only tokens in the native vocabulary of the transformer models 80a-80n may resolve successfully and any tokens in the alternate vocabulary may have no corresponding embedding vectors (e.g., cannot be embedded). The transformer models 80a-80n may be architecturally incapable of generating authoritative content, because the content has no representation in the embedding space of the transformer models 80a-80n. Post-inference substitution at positions flagged by the attention weight detector 362 may provide the populated authoritatively bound role 200 in the structured output 154 (e.g., drawn directly from the fixed buffer 272 without passing through the embedding stage). The vocabulary boundary may be enforced at the embedding stage by the absence of embedding vectors for the alternate vocabulary, and the absence may provide a hard structural prohibition on generating the authoritative content by the transformer models 80a-80n.

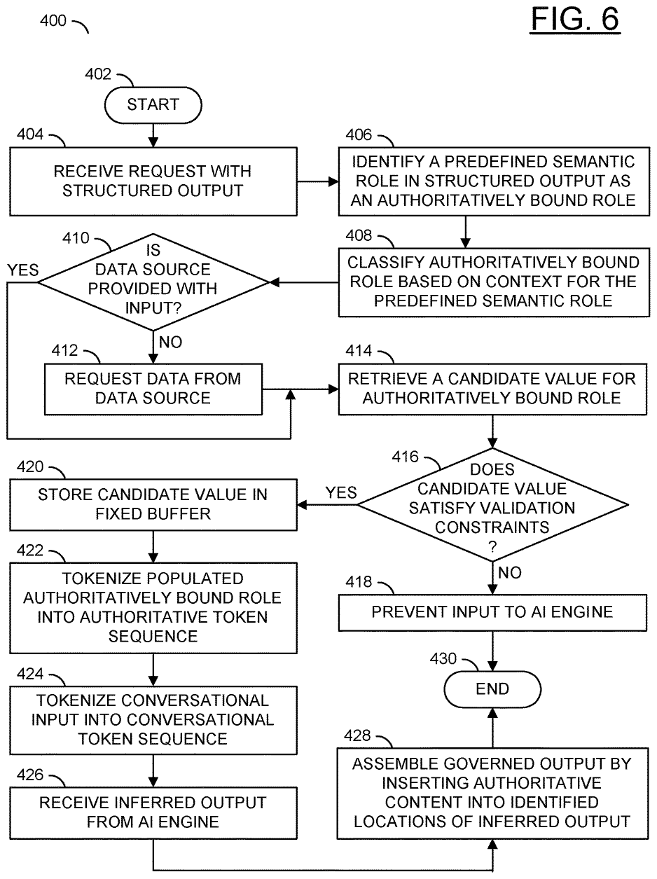

Referring to FIG. 6, a method (or process) 400 is shown. The method 400 may govern output of a generative AI engine to populate a structured output with validated content that is bound to an authoritative source. The method 400 generally comprises a step (or state) 402, a step (or state) 404, a step (or state) 406, a step (or state) 408, a decision step (or state) 410, a step (or state) 412, a step (or state) 414, a decision step (or state) 416, a step (or state) 418, a step (or state) 420, a step (or state) 422, a step (or state) 424, a step (or state) 426, a step (or state) 428, and a step (or state) 430.

The step 402 may start the method 400. The method 400 may be configured to identify the semantic roles 162a-162n of the structured output template 152 and/or tokenize the populated authoritatively bound role 200 for assembly into a governed output into one or more of the validated semantic roles 190a-190n. In the step 404, the governance layer 100 may be configured to receive the input request with a structured output. For example, the governance layer 100 may receive the signal REQUEST comprising the structured output template 152. The structured output template 152 may indicate a format and/or a pattern of text desired by the user for the output from the AI engine 80. Next, in the step 406, the governance layer 100 may identify a predefined semantic role in the structured output template 152 as an authoritatively bound role. For example, the role identification module 180 may analyze the semantic roles 162a-162n to determine which of the semantic roles 162a-162n may be authoritatively bound role(s). In the step 408, the governance layer 100 may classify the authoritatively bound role(s) based on the context for the semantic roles 162a-162n. The role identification module 180 may classify the authoritatively bound role(s) from an analysis of the semantic roles 162a-162n. For example, the role identification module 180 may analyze the authoritatively bound role(s) to determine role attributes (e.g., present the signal RATTR). Next, the method 400 may move to the decision step 410.

In the decision step 410, the governance layer 100 may determine whether the authoritative data source has been provided with the input. For example, the client device 52 may provide the signal SOURCE along with the signal REQUEST. In another example, the information to respond to the input request may be retrieved from an external source. If the authoritative data source has been provided with the input, then the method 400 may move to the step 414. If the authoritative data source has not been provided with the input, then the method 400 may move to the step 412. In the step 412, the governance layer 100 may request data from the authoritative data source 54. For example, the data retrieval module 252 may generate the signal REQ comprising a request for the authoritative data stored in the authoritative data source 54, and the authoritative data source 54 may provide the signal SOURCE comprising the requested authoritative data. Next, in the step 414, the governance layer 100 may retrieve a candidate value for the authoritatively bound role. For example, the role identification module 180 and/or the data retrieval module 252 may analyze the signal SOURCE for information that may be used as a candidate value to fill the semantic roles 162a-162n that may be identified as the authoritatively bound role(s) (e.g., generate the signal CDVAL). Next, the method 400 may move to the decision step 416.

In the decision step 416, the governance layer 100 may determine whether the candidate value satisfies the validation constraints. For example, the constraint validation module 182 may evaluate the candidate value(s) (e.g., the constraint validation module 182 may receive the signal CDVAL and/or the signal RATTR to validate one or more constraints). The constraint validation module 182 compare the candidate value(s) to one or more validation constraints according to the role attribute(s) for the authoritatively bound role(s). The constraint validation module 182 may be configured to evaluate the candidate value(s) generated by the role identification module 180 based on the role attributes for the authoritatively bound roles. If the candidate value does not satisfy the validation constraints, then the method 400 may move to the step 418. In the step 418, the governance layer 100 may prevent the AI engine 80 from receiving the input request. For example, when no suitable data for the structured output template 152 is available, then no input should be provided to the AI engine 80 (e.g., to avoid a possibility of hallucinations). For example, a medical record being unavailable may mean that no prescription may be ordered because sufficient information is not available for forming the prescription. Next, the method 400 may move to the step 430. In the decision step 416, if the candidate value satisfies the validation constraints, then the method 400 may move to the step 420.

In the step 420, the governance layer 100 may store the populated authoritatively bound role 200 in the memory buffer 256. For example, the fixed buffer 272 may receive the signal ABR to store the populated authoritatively bound role 200. Next, in the step 422, the token sequencer 102 and/or one of the tokenization modules 310a-310b may tokenize the populated authoritatively bound role 200 into the authoritative token sequence 332a-332n. In the step 424, the token sequencer 102 and/or one of the tokenization modules 310a-310b may tokenize the conversational input into the conversational token sequence 330a-330n. The token sequencer 102 and/or one of the tokenization modules 310a-310b may receive the signal REQUEST and/or the signal ABR, perform the tokenization operations and generate the signal AWT. The signal AWT may be presented to the AI engine 80. The steps 422-424 may be shown sequentially for illustrative purposes. However, the steps 422-424 may be performed in parallel and/or substantially in parallel. Next, the method 400 may move to the step 426.

In the step 426, the governance layer 100 may receive the inferred output from the AI engine 80. For example, the AI engine 80 may generate the signal PR-FL in response to the signal AWT. The inferred output may be stored in the generative buffer 274. Next, in the step 428, the governance layer 100 may assemble the governed output by inserting the authoritative content into the identified locations of the inferred output. For example, the signal PR-FL may comprise identified locations for inserting the populated authoritatively bound role 200 based on the signal AWT. The assembly module 184 may insert the populated authoritatively bound role 200 from the authoritative token sequence 332a-332n stored in the fixed buffer 272 into the signal PR-FL. For example, the assembly module 184 may generate the signal GOV in response to the signal ABR and the signal PR-FL. The signal GOV may be the structured output 154 generated by the governance layer 100. For example, the structured output 154 may comprise data from the signal ABR for the validated semantic roles 190a-190n that have been identified as the authoritatively bound roles and the signal PR-FL for the filled structural components 160a′-160n′ and the validated semantic roles 190a-190n for the semantic roles 162a-162n that have not been identified as authoritatively bound roles. Next, the method 400 may move to the step 430. The step 430 may end the method 400.

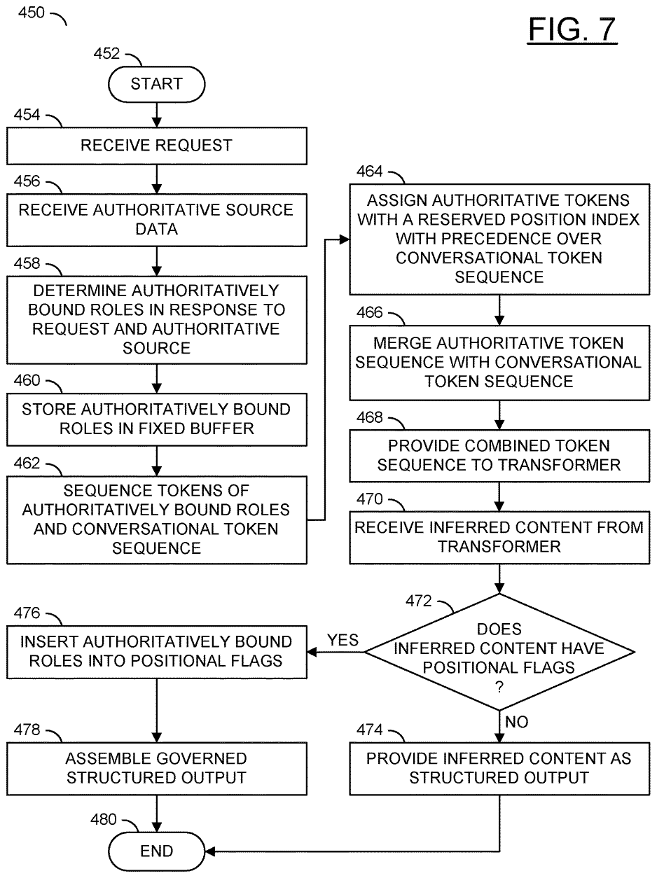

Referring to FIG. 7, a method (or process) 450 is shown. The method 450 may generate trusted AI output using a tokenization architecture that combines an authoritative token sequence with a conversational token sequence. The method 450 generally comprises a step (or state) 452, a step (or state) 454, a step (or state) 456, a step (or state) 458, a step (or state) 460, a step (or state) 462, a step (or state) 464, a step (or state) 466, a step (or state) 468, a step (or state) 470, a decision step (or state) 472, a step (or state) 474, a step (or state) 476, a step (or state) 478, and a step (or state) 480.

The step 452 may start the method 450. In the step 454, the governance layer 100 may receive the input request. For example, request conditioner 254 may condition the signal REQUEST for the matched vocabulary tokenization architecture 302. Next, in the step 456, the data retrieval module 252 may receive the authoritative source data. For example, one or more of the multiple authoritative data sources 54a-54c may provide the signal SOURCE. In the step 458, the role identification module 180 may determine the authoritatively bound roles in response to the input request and/or the authoritative source data. Next, in the step 460, the governance layer 100 may store the populated authoritatively bound role 200 in the fixed buffer 272. For example, the matched vocabulary tokenization architecture 302 may have received the conversational input and the authoritative input. Next, the method 450 may move to the step 462.

In the step 462, the token sequencer 102 may sequence the conversational token sequence 330a-330n and the authoritative token sequence 332a-332n. For example, the tokenization modules 310a-310b may generate the conversational token sequence 330a-330n in response the signal REQUEST (e.g., by the tokenization module 310a) and the authoritative token sequence 332a-332n in response to the ABR (e.g., by the tokenization module 310b) and the token sequencer 102 may perform sequencing operations. Next, in the step 464, the token sequencer 102 may assign the authoritative token sequence 332a-332n with a reserved position index that has precedence over the conversational token sequence 330a-330n. In one example, the positional precedence may overweight the authoritative token sequence 332a-332n with respect to the conversational token sequence 330a-330n. In the step 466, the matched vocabulary tokenization architecture 302 may merge the authoritative token sequence 332a-332n with the conversational token sequence 330a-330n. For example, the token sequencer 102 may provide the sequenced authoritative token sequence 332a-332n and the conversational token sequence 330a-330n to embedding stage (e.g., the transformer inference pipeline) to enable the token embedding module 312 and the positional encoding module 314 and the token sequence combiner 316 to combine the token embedding vectors (e.g., the signal TE_VEC_REQ and the signal TE_VEC_ABR) and the positional encoding vectors (e.g., the signal PE_VEC_REQ and the signal PE_VEC_ABR). Next, in the step 468, the input embedding module 318 may provide the combined token sequence to the transformer models 80a-80n. For example, the input embedding module 318 may perform input embedding on the combined token embedding vectors and the positional encoding vectors to generate the signal AWT. The signal AWT comprising the combined token sequence with positional precedence for the authoritative token sequence 332a-332n may be presented to the transformer models 80a-80n. In the step 470, the generative buffer 274 may receive the inferred content from the transformer models 80a-80n. For example, the transformer models 80a-80n may generate the probabilistically inferred content with the identification information (e.g., the signal PR-FL) in response to the combined token sequence with positional precedence (e.g., the signal AWT). Next, the method 450 may move to the decision step 472.

In the decision step 472, the assembly module 184 may determine whether the inferred content has positional flags. For example, in response to some input requests, no authoritatively bound content may be beneficial and/or necessary (e.g., for general conversational content that does not rely on providing precise values in response). If the inferred content does not have positional flags, then the assembly module 184 may provide the inferred content as the structured output 154. For example, the assembly module 184 may not have the populated authoritatively bound role 200 to insert and the assembly module 184 may forward the signal PR-FL as output. Next, the method 450 may move to the step 480.

In the decision step 472, if the inferred content does have the positional flags, then the method 450 may move to the step 476. In the step 476, the assembly module 184 may insert the populated authoritatively bound role 200 into the positional flags of the probabilistically inferred content. For example, the assembly module 184 may receive the signal ABR stored in the fixed buffer 272 and determine where to insert the populated authoritatively bound role 200. Next, in the step 478, the assembly module 184 may assemble the governed structured output. For example, inserting the populated authoritatively bound role 200 into the positional flags of the probabilistically inferred content may provide governed output. The governed output (e.g., the signal GOV) may comprise the structured output 154. Next, the method 450 may move to the step 480. The step 480 may end the method 450.

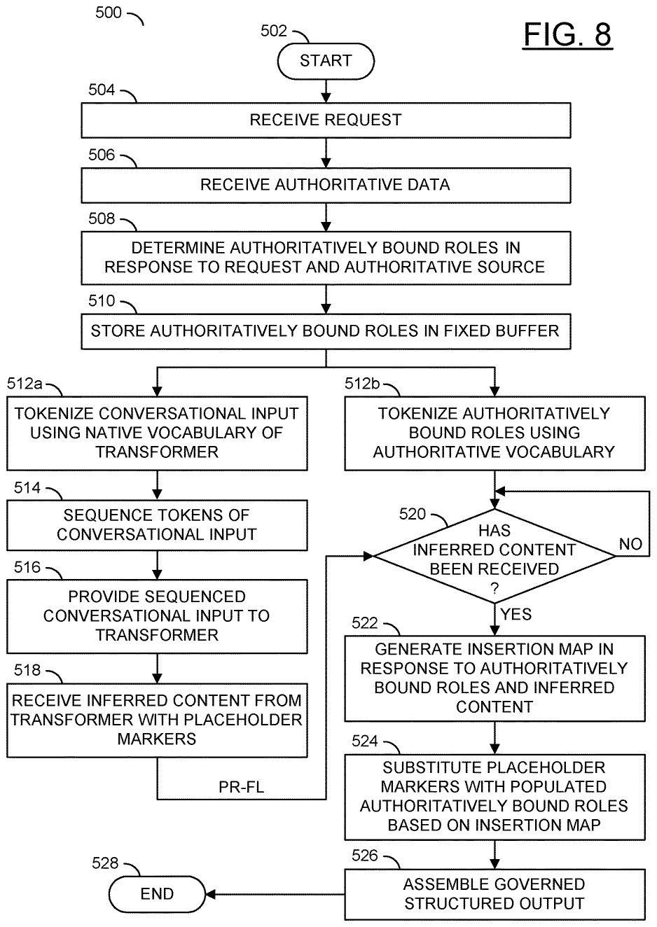

Referring to FIG. 8, a method (or process) 500 is shown. The method 500 may generate trusted AI output using a tokenization architecture that generates a conversational token sequence and an authoritative token sequence using a different vocabulary. The method 500 generally comprises a step (or state) 502, a step (or state) 504, a step (or state) 506, a step (or state) 508, a step (or state) 510, a step (or state) 512a, a step (or state) 512b, a step (or state) 514, a step (or state) 516, a step (or state) 518, a decision step (or state) 520, a step (or state) 522, a step (or state) 524, a step (or state) 526, and a step (or state) 528.

The step 502 may start the method 500. In the step 504, the governance layer 100 may receive the input request. For example, request conditioner 254 may condition the signal REQUEST for the authoritative bypass tokenization architecture 352. Next, in the step 506, the data retrieval module 252 may receive the authoritative source data. For example, one or more of the multiple authoritative data sources 54a-54c may provide the signal SOURCE. In the step 508, the role identification module 180 may determine the authoritatively bound roles in response to the input request and/or the authoritative source data. Next, in the step 510, the governance layer 100 may store the populated authoritatively bound role 200 in the fixed buffer 272. For example, the authoritative bypass tokenization architecture 352 may have received the conversational input and the authoritative input. Next, the method 500 may move to the steps 512a-512b. The steps 512a-512b may be performed in parallel and/or substantially in parallel.

In the step 512a, the AI model vocabulary tokenization module 360a tokenize the conversational input using the native vocabulary of the transformer models 80a-80n. For example, the AI model vocabulary tokenization module 360a may present the conversational token sequence 330a-330n to the token sequencer 102. Next, the method 500 may move to the step 514. In the step 512b, the authoritative vocabulary tokenization module 360b may tokenize the populated authoritatively bound role 200 using an authoritative vocabulary. For example, the authoritative vocabulary tokenization module 360b may present the alternate vocabulary authoritative token sequence 332a′-332n′ to the attention weight detector 362. The authoritative vocabulary may be different from the AI model vocabulary, resulting in the alternate vocabulary authoritative token sequence 332a′-332n′ being incompatible with the transformer models 80a-80n. Next, the method 500 may move to the decision step 520.

In the step 514, the token sequencer 102 may sequence the tokens of the conversational input. In some embodiments, the token sequencer 102 may provide information for the transformer models 80a-80n to insert the placeholder markers and/or select a type of placeholder marker for the locations that should provide the populated authoritatively bound role 200. For example, the token sequencer 102 may provide the conversational token sequence 330a-330n to the embedding stage (e.g., the transformer inference pipeline). Next, in the step 516, the authoritative bypass tokenization architecture 352 may provide the sequenced conversational input to the transformer models 80a-80n. For example, the token embedding module 312 and the positional encoding module 314 may perform token embedding and positional encoding to provide the token embedding vector (e.g., the signal TE_VEC_REQ) and the positional encoding vector (e.g., the signal PE_VEC_REQ) and the input embedding module 318 may perform input embedding to provide the sequenced conversational input to the transformer models 80a-80n as the signal AWT. In the step 518, the generative buffer 274 may receive the inferred content from the transformer models 80a-80n with placeholder markers. For example, the transformer models 80a-80n may generate the signal PR-FL comprising the placeholder markers in response to the sequenced conversational input in the signal AWT.

In the decision step 520, the authoritative bypass tokenization architecture 352 may determine whether the inferred content has been received. For example, the governance state stored in the evaluative object store 270 may track whether the generative buffer 274 has stored the inferred content with placeholder markers from the transformer models 80a-80n. If the inferred content has not been received, then the method 500 may return to the decision step 520. If the inferred content has been received, then the method 500 may move to the step 522. In the step 522, the attention weight detector 362 may generate the insertion map in response to the alternate vocabulary authoritative token sequence 332a′-332n′ and the inferred content. For example, the attention weight detector 362 may generate the signal INS-MAP in response to the signal PR-FL and the signals AT_A-AT_N. Next, in the step 524, the assembly module 184 may substitute the placeholder markers with the populated authoritatively bound role 200 based on the insertion map. For example, the insertion map may indicate which of the placeholder markers should be inserted with which of the alternate vocabulary authoritative token sequence 332a′-332n′. In the step 526, the assembly module 184 may assemble the governed structured output. For example, substituting the populated authoritatively bound role 200 for the placeholder markers may provide the signal GOV. The signal GOV may comprise the structured output 154. Next, the method 500 may move to the step 528. The step 528 may end the method 500.

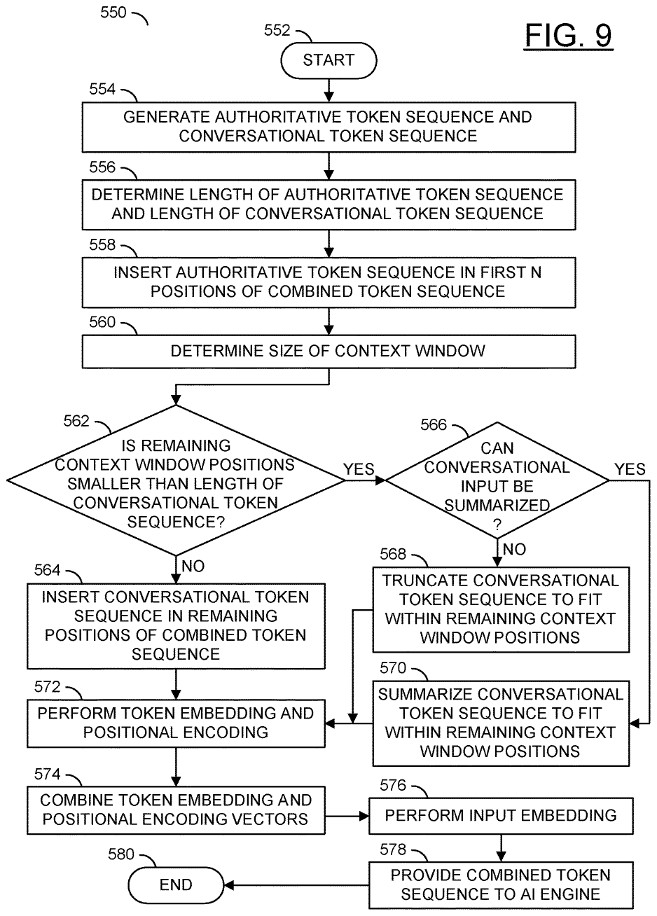

Referring to FIG. 9, a method (or process) 550 is shown. The method 550 may assign tokens to a positional index in a combined token sequence. The method 550 generally comprises a step (or state) 552, a step (or state) 554, a step (or state) 556, a step (or state) 558, a step (or state) 560, a decision step (or state) 562, a step (or state) 564, a decision step (or state) 566, a step (or state) 568, a step (or state) 570, a step (or state) 572, a step (or state) 574, a step (or state) 576, a step (or state) 578, and a step (or state) 580.

The step 552 may start the method 550. In the step 554, the tokenization modules 310a-310b may generate the conversational token sequence 330a-330n and the authoritative token sequence 332a-332n. Next, in the step 556, the token sequencer 102 may determine a length of the authoritative token sequence 332a-332n and a length of the conversational token sequence 330a-330n. For example, the authoritative token sequence 332a-332n may have a length and/or size of N tokens. In the step 558, the token sequencer 102 may insert the authoritative token sequence 332a-332n into the first N positions of the combined token sequence. For example, placing the authoritative token sequence 332a-332n in the first N positions may ensure that the authoritative token sequence 332a-332n have positional precedence over the conversational token sequence 330a-330n after the token embedding and positional encoding are performed during the embedding stage. Next, in the step 560, the token sequencer 102 may determine the size of the context window. For example, the size of the context window may be determined based on an amount of memory available for the governance layer 100 by the cloud computing service 58, the amount of memory available to the transformer models 80a-80n, an amount of tokens available for the user account making the input request, etc. Next, the method 550 may move to the decision step 562.

In the decision step 562, the token sequencer 102 may determine whether the remaining context window positions are smaller than the length of the conversational token sequence 330a-330n. For example, the token sequencer 102 may compare the size of the context window to the amount of positions already occupied by the authoritative token sequence 332a-332n and the length of the conversational token sequence 330a-330n. If there are sufficient context window positions available, then the method 550 may move to the step 564. In the step 564, the token sequencer 102 may insert the conversational token sequence 330a-330n into the remaining positions for the combined token sequence and provide the merged token sequence to the embedding stage. Next, the method 550 may move to the step 572.

In the decision step 562, if there are insufficient context window positions available, then the method 550 may move to the decision step 566. In the decision step 566, the matched vocabulary tokenization architecture 302 may determine whether the conversational input may be summarized. For example, the token sequencer 102 may be capable of reducing the length of the conversational token sequence 330a-330n without changing the meaning of the conversational input based on the particular conversational input. If the conversational input is incapable of being summarized, then the method 550 may move to the step 568. In the step 568, the token sequencer 102 may truncate one or more of the conversational token sequence 330a-330n to enable the conversational token sequence 330a-330n to fit within the remaining context window positions and provide the merged token sequence to the embedding stage. Next, the method 550 may move to the step 572. In the decision step 566, if the conversational input can be summarized, then the method 550 may move to the step 570. In the step 570, the token sequencer 102 may summarize the conversational token sequence 330a-330n to fit within the remaining context window positions and provide the merged token sequence to the embedding stage. Next, the method 550 may move to the step 572.

In the step 572, the matched vocabulary tokenization architecture 302 may perform the token embedding and the positional encoding of the embedding stage to generate the position encoding vectors and the token embedding vectors for the both the conversational token sequence 330a-330n and the authoritative token sequence 332a-332n. Next, in the step 574, the token sequence combiner 316 may combine the token embedding and positional encoding vectors. In the step 576, the input embedding module 318 may perform input embedding to generate the signal AWT. Next, in the step 578, the matched vocabulary tokenization architecture 302 may provide the combined token sequence to the AI engine 80. Next, the method 550 may move to the step 580. The step 580 may end the method 550.

The functions performed by the diagrams of FIGS. 1-9 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. Execution of instructions contained in the computer product by the machine, may be executed on data stored on a storage medium and/or user input and/or in combination with a value generated using a random number generator implemented by the computer product. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROMs (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, cloud servers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is(are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The designations of various components, modules and/or circuits as “a” “n”, when used herein, disclose either a singular component, module and/or circuit or a plurality of such components, modules and/or circuits, with the “n” designation applied to mean any particular integer number. Different components, modules and/or circuits that each have instances (or occurrences) with designations of “a” “n” may indicate that the different components, modules and/or circuits may have a matching number of instances or a different number of instances. The instance designated “a” may represent a first of a plurality of instances and the instance “n” may refer to a last of a plurality of instances, while not implying a particular number of instances.

While the invention has been particularly shown and described with reference to embodiments thereof, it will be understood by those skilled in the art that various changes in form and details may be made without departing from the scope of the invention.

1. A computer-implemented method for prioritizing authoritative source content within a transformer inference pipeline, the method comprising:
receiving an input comprising (i) a request from an end user associated with structured output comprising one or more predefined semantic roles and (ii) a data source;
identifying (i) at least one of said predefined semantic roles as an authoritatively bound role and (ii) conversational input from said predefined semantic roles prior to execution of transformer model;
generating a populated authoritatively bound role in response to said authoritatively bound role and said data source;
storing said populated authoritatively bound role in a fixed value buffer;
tokenizing said populated authoritatively bound role into an authoritative token sequence;
tokenizing said conversational input into a conversational token sequence;
receiving a probabilistically inferred output from said transformer model in response to at least said conversational token sequence; and
assembling a governed output corresponding to said structured output in response to inserting said populated authoritatively bound role stored in said fixed value buffer into identified locations of said probabilistically inferred output.

2. The computer-implemented method according to claim 1, further comprising the step of:
merging said authoritative token sequence with said conversational token sequence into a combined token sequence in response to assigning said authoritative token sequence with a reserved positional index that has positional precedence over said conversational token sequence, wherein
(i) said probabilistically inferred output generated by said transformer model in response to said conversational token sequence merged with said authoritative token sequence comprises said reserved positional index, and
(ii) said identified locations of said probabilistically inferred output correspond to said reserved positional index of said probabilistically inferred output.

3. The computer-implemented method according to claim 2, wherein merging said authoritative token sequence with said conversational token sequence before operations by said transformer model is a positional operation configured to establish an order of said populated authoritatively bound role with respect to said conversational token sequence.

4. The computer-implemented method according to claim 2, wherein a transformer pipeline is configured to perform token embedding to map token identifiers in said combined token sequence to a semantic vector using a shared embedding matrix.

5. The computer-implemented method according to claim 4, wherein said tokenizing to generate said authoritative token sequence and said tokenizing to generate said conversational token sequence is performed with a same vocabulary to prevent mismatch of said shared embedding matrix that corrupts an input to said transformer model.

6. The computer-implemented method according to claim 2, wherein a length of said combined token sequence is selected to fit within a context window of said transformer model.

7. The computer-implemented method according to claim 2, wherein (i) said authoritative token sequence occupies positions 1 through N of said combined token sequence where N is a length of said authoritative token sequence and (ii) remaining positions in a context window for said combined token sequence are used for said conversational token sequence.

8. The computer-implemented method according to claim 2, wherein assigning said authoritative token sequence to said reserved positional index prior to positional encoding structurally biases attention of said transformer model toward said populated authoritatively bound role relative to said conversational input.

9. The computer-implemented method according to claim 2, further comprising allocating different ranges for said reserved positional index to multiple authoritative sources available as said data source based on a prioritization hierarchy.

10. The computer-implemented method according to claim 2, wherein merging said authoritative token sequence with said conversational token sequence into said combined token sequence further comprises inserting one or more boundary markers separating said authoritative token sequence and said conversational token sequence.

11. The computer-implemented method according to claim 1, wherein (i) said identified locations comprise placeholder markers inserted by said transformer model and (ii) assembling said governed output comprises substituting said populated authoritatively bound role for said placeholder markers.

12. The computer-implemented method according to claim 11, wherein said placeholder markers comprise native vocabulary generated by said transformer model that indicates incompleteness.

13. The computer-implemented method according to claim 12, wherein said native vocabulary for said placeholder markers comprise one or more of a reserved gap marker token, a low-confidence token sequence, and explicit placeholder.

14. The computer-implemented method according to claim 11, wherein (i) said tokenizing to generate said authoritative token sequence is assigned a separate domain-specific vocabulary from said tokenizing to generate said conversational token sequence and (ii) said authoritative token sequence is stored in said fixed value buffer.

15. The computer-implemented method according to claim 14, wherein (i) said authoritative token sequence is not provided to said transformer model and (ii) said conversational token sequence is provided to said transformer model in a native vocabulary of said transformer model.

16. The computer-implemented method according to claim 11, wherein said assembling of said governed output comprises an attention weight detector configured to read an attention pattern at said identified locations to determine said placeholder markers.

17. The computer-implemented method according to claim 16, wherein (i) said assembling of said governed output further comprises generating an insertion point map in response to said attention weight detector and (ii) said insertion point map comprises each of said placeholder markers for substituting in said authoritative token sequence and discarding tokens from said probabilistically inferred output corresponding to said placeholder markers.

18. The computer-implemented method according to claim 11, wherein substituting said populated authoritatively bound role for said placeholder markers enables said governed output to comprise verbatim authoritative content from said data source that maintains positional integrity.

19. The computer-implemented method according to claim 1, wherein said data source comprises one or more of a user declaration, an external system, or a dynamically inferred source.

20. A computer-implemented method for prioritizing authoritative source content within a transformer inference pipeline, the method comprising:
receiving (i) a request comprising a conversational input from an end user and (ii) a populated authoritatively bound role from a data source;
storing said populated authoritatively bound role in a fixed value buffer;
tokenizing said populated authoritatively bound role into an authoritative token sequence;
tokenizing said conversational input into a conversational token sequence;
receiving a probabilistically inferred output from a transformer model in response to at least said conversational token sequence; and
assembling a governed output in response to inserting said populated authoritatively bound role stored in said fixed value buffer into identified positions of said probabilistically inferred output.
